(19) United States
(12) Patent Application Publication
(10) Pub. No.: US 2004/0260039 A1
(43) Pub. Date: Dec. 23, 2004

(54) Process for producing organic compound epoxy resin composition, cured article obtained from the epoxy resin, and semiconductor device obtained with epoxy resin

(76) Inventors: Naritoshi Yoshimura, Sodegaura-shi (JP); Tadahito Nobori, Sodegaura-shi (JP); Yoshihiro Yamamoto, Sodegaura-shi (JP); Takaomi Hayashi, Sodegaura-shi (JP); Shinji Kiyono, Sodegaura-shi (JP); Tatsuhiro Urakami, Sodegaura-shi (JP); Tomoyuki Kawabata, Sodegaura-shi (JP); Sunao Maeda, Sodegaura-shi (JP)

Correspondence Address: BURNS DOANE SWECKER & MATHIS L L P, POST OFFICE BOX 1404, ALEXANDRIA, VA, 22313-1404, US

(21) Appl. No.: 10/497,466

(22) PCT Filed: Jul. 11, 2003
(86) PCT No.: PCT/JP03/08836

(30) Foreign Application Priority Data
Jul. 12, 2002 (JP) 2002-204903

(51) Int. Cl. C08G 59/14

(52) U.S. Cl. 525/533

(57) ABSTRACT

There are disclosed a process for producing an organic compound in the presence of a particular substituted triarylphosphine compound, particularly, a process for producing an oxyalkylene derivative at a high yield using the above compound which is very active and easy to handle, by reacting an organic epoxy compound with a carboxylic acid ester, a carboxylic acid anhydride, a sulfonic acid ester or a carbonic acid ester, and an epoxy resin composition using a particular substituted triarylphosphine compound as a curing accelerator, a cured material of the composition and a semiconductor device using the composition.

### TECHNICAL FIELD

The present invention relates to a process for producing an organic compound using a substituted triarylphosphine compound as a catalyst (the first invention), as well as to an epoxy resin composition containing a substituted triarylphosphine compound as a curing accelerator, a cured material of the composition, and a semiconductor device-obtained by using the composition (the second invention).

That is, the first invention relates to a process for producing a useful organic compound by reacting raw material organic compounds in the presence of a phosphine compound represented by the following formula (1).

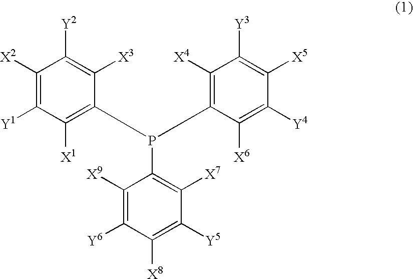

[in the above formula, X¹ to X⁹ and Y¹ to Y⁶ are each independently a hydrogen atom, an aliphatic or alicyclic hydrocarbon group of 1 to 10 carbon atoms, an aromatic hydrocarbon group of 6 to 10 carbon atoms, an alkoxy group of 1 to 10 carbon atoms, or an aryloxy group of 6 to 10 carbon atoms, with a proviso that at least three of X¹ to X⁹ are an alkoxy group of 1 to 10 carbon atoms].

The first invention relates further to an effective process for producing an oxyalkylene derivative by reacting an epoxy compound with a carboxylic acid ester, a carboxylic acid anhydride, a sulfonic acid ester or a carbonic acid ester. These oxyalkylene derivatives are very important compounds as an intermediate for synthesis of an agricultural chemical or a medicine, a polymer material, etc.

The second invention relates to an epoxy resin composition which is superior in curability, mechanical strengths and moisture resistance and accordingly in cracking resistance in reflow soldering and further superior in electrical reliability and, therefore, shows such curability as is sufficient when used for encapsulation of semiconductor integrated circuit and moreover gives excellent productivity in industrial production. The second invention relates further to a cured material of the epoxy resin composition as well as to a semiconductor device obtained by encapsulating a semiconductor integrated circuit using the epoxy resin composition.

### BACKGROUND ART

It is well known that when an epoxy compound is reacted with a arboxylic acid ester, a carboxylic acid anhydride, a sulfonic acid ester or a carbonic acid ester to produce an oxyalkylene derivative, a base such as a tertiary amine, a quaternary ammonium salt, a quaternary phosphonium salt or the like acts as a catalyst to promote the above reaction (K. Funabashi, Bulletin of the Chemical Society of Japan, Vol. 52, p. 1488, 1979; and Tadatomi Nishikubo, Journal of Synthetic Organic Chemistry, Japan, Vol. 49, No. 3, p. 219, 1991). However, a basic catalyst such as a tertiary amine, a quaternary ammonium salt, a quaternary phosphonium salt or the like has no sufficient catalytic activity.

Therefore, when any of these basic catalysts is used, the amount and concentration thereof need be made large or a reaction must be carried out under severe conditions, in order to complete the reaction; as a result, there are problems such as occurrence of side reaction, decomposition of raw material, product, etc., and the like.

In view of the above situation, the present applicant previously proposed a process for producing an oxyalkylene derivative by contacting an organic compound, especially an epoxy compound with an alcohol, a thiol, a phenol, a thiophenol, a carboxylic acid, a sulfonic acid, a carboxylic acid ester, a carboxylic acid anhydride, a sulfonic acid ester or a carbonic acid ester in the presence of a phosphine oxide compound represented by the following formula (11) (JP-A-2000-80049).

((R₂N)₃P=N)₃PO.x(H₂O) (11)

[in the formula (11), eighteen Rs may be the same or different and are a hydrogen atom or a hydrocarbon group of 1 to 10 carbon atoms; and x is a molar ratio of the amount of water molecules, and is 0 to 5.0].

The phosphine oxide compound represented by the formula (11), however, has hygroscopicity generally and tends to become a hydrous compound or a hydrate. Therefore, care is required in its storage and use, in some cases.

The present applicant also proposed a process for producing a 1,2-dioxyethane derivative by contacting an epoxy compound with a carboxylic acid ester, a carboxylic acid anhydride or a carbonic acid ester in the presence of a phosphazenium compound represented by the following formula (12) (JP-A-2000-128830).

[((R′₂N)₃P=N)₄P]⁺.Z⁻ (12)

[in the formula (12), twenty-four R's may be the same or different and are a hydrocarbon group of 1 to 10 carbon atoms; and Z⁻ is a halogen anion, a hydroxy anion, an alkoxy anion, an aryloxy anion or a carboxy anion].

The phosphazenium compound represented by the above formula (12), however, is an ionic compound which is a combination of a phosphazenium cation and a counter anion thereof, and remains in the product obtained, in some cases. Therefore, when the 1,2-dioxyethane derivative produced is used in such an application field (e.g. an electronic & information material) as the properties of the product are adversely affected by the ionic compound, precise removal of the ionic compound remaining in the product is necessary, which may require a complicated operation.

Hence, development of a nonionic compound showing a high effect for promotion of reaction is strongly desired.

Meanwhile, phosphine compounds obtained by introducing methoxy group (electron-donating group) into triphenylphosphine (a representative base and a tertiary phosphine), that is, tris(2,6-dimethoxyphenyl)phosphine and tris(2,4,6-trimethoxyphenyl)phosphine were reported by Wada et al. in recent years as a nonionic compound which has a high basicity, is stable to air, and is easy to handle in storage and use (Masanori Wada and Shogo Higashizaki, Journal of the Chemical Society, Chemical Communications, p. 482,1984).

Wada et al. reported a possibility of production of a 2-hydroxyalkylphosphonium salt by reaction of one of the above phosphine compounds with an epoxy compound (Masanori Wada, Journal of Synthetic Organic Chemistry, Japan, Vol. 44, No. 10, p. 957, 1986); a Michael addition reaction of a nitroalkane using the above phosphine compound as a catalyst (Masanori Wada, Aki Tsuboi, Kumiko Nishimura and Tatsuo Erabi, Nippon Kagaku Kaishi, No. 7, p. 1284, 1987); and so forth.

However, no study has been made on production of an oxyalkylene derivative by contacting an epoxy compound with a carboxylic acid ester, a carboxylic acid anhydride, a sulfonic acid ester or a carbonic acid ester in the presence of tris(2,6-dimethoxyphenyl)phosphine and tris(2,4,6-trimethoxyphenyl)phosphine.

Next, description is made on the background art of the second invention.

Integrated circuits (IC) and large-scale integrated circuits (LSI) are protected from their external environments, etc. by an encapsulating material protecting IC or LSI. As to the encapsulating material, encapsulation using a metal or a ceramic shifted to resin encapsulation in recent years, and epoxy resin encapsulation is a main stream nowadays. In particular, epoxy resin compositions using a phenol resin as a curing agent are used in a large amount owing to the balance in cost and properties. Of them, there are used in a large amount those epoxy resin compositions using, as an epoxy resin, an o-cresol novolac type epoxy resin or a biphenol type epoxy resin and, as a curing agent, a phenol novolac resin or a phenol aralkyl resin.

These resin compositions are superior in heat resistance but inferior in moisture resistance (these properties are part of the requirements for encapsulating materials). Various improvements have been made for this problem. However, in these resin compositions, there takes place a curing reaction of epoxy group caused by phenolic hydroxyl group; hydroxyl group is formed as shown in the following formula; hygroscopicity owing to the hydroxyl group arises; therefore, there was apparently a limitation with respect to the improvement in moisture resistance.

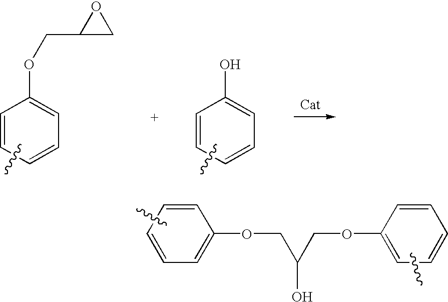

Meanwhile, with the recent remarkable progress in electric and electronic industries, the properties required for encapsulating materials are becoming increasingly severe year by year.

In particular, the requirement for cracking resistance in reflow soldering is the severest, and the major reason therefor is considered to be associated with the water content due to the moisture absorption of resin in encapsulating material.

As a countermeasure for the above matter, it has been attempted to achieve a larger hydroxyl group equivalent by, for example, making larger the linkage group between phenols or converting the phenol to naphthol or the like and thereby suppress the above-mentioned hydroxyl group density after curing and accordingly the hygroscopicity of resin.

In such a means, although the hygroscopicity of resin can be suppressed to some extent by achieving a larger hydroxyl group equivalent, the extent of the suppression is not satisfactory and, moreover, a crosslink density becomes very low; as a result, there has been a problem that other properties such as heat resistance, mechanical strengths and the like are sacrificed.

As one method for solving this problem, there was proposed a reaction between epoxy group and ester group, such as shown in JP-A-62-53327. In the literature, however, there is no indication on any catalyst having practically curing effect.

There was further disclosed a technique for obtaining an encapsulating material for semiconductor by esterifying the hydroxyl group of a phenol resin and using the resulting ester as a curing agent for epoxy resin, in JP-A-8-143642, JP-A-9-235451, etc.

In any of these literatures, however, there is no description on study of curing accelerator, and it is described that conventional general-purpose curing accelerators such as phosphine type compounds, imidazole type compounds and diazabicyclo type compounds can be used widely as a curing accelerator.

Meanwhile, the second invention reveals that only a triarylphosphine containing, as a skeleton, aryl groups having an electron-donating group(s) at a particular position(s) can allow a reaction between epoxy group and ester group to proceed specifically at a practical efficiency.

This difference is clear from that in JP-A-8-143642, JP-A-9-235451, etc., control is made so that in an ester group-containing resin used as a curing agent, the phenolic hydroxyl group of phenol resin to be esterified remains unreacted by an amount of 10 mole % or more and also from that according to the specific description in Examples, the ratio of esterification stays at a level of up to 75%. It is estimated from this that no practical curing reaction proceeds when any conventional general-purpose curing accelerator is used and that a cured material is formed by a curing reaction based on the phenolic hydroxyl group allowed to remain partially or by a self-polymerization of epoxy resin.

Thus, conventional curing accelerators used in a curing reaction between epoxy resin and phenol resin show no effective catalytic activity in a curing reaction between epoxy resin and ester group-containing resin.

Further, it was clarified by the present inventors that conventional representative curing accelerators used in epoxy-phenol curing, for example, phosphine type compounds (e.g. triphenylphosphine) and imidazole type compounds (e.g. 2-methylimidazole) show no acceleration effect in an epoxy-ester addition reaction (JP-A-2000-327751).

Thus, an ordinary epoxy resin and an esterified phenol resin obtained by acylating the hydroxyl group of a phenol resin are unable to give a cured material when an epoxy resin-phenol resin curing accelerator such as ordinary triphenylphosphine or the like is used.

Therefore, in the technique for curing an epoxy resin with an esterified phenol resin, it has been desired to develop a technique for providing a sufficient curing activity using a catalyst of high industrial availability.

### DISCLOSURE OF THE INVENTION

Hence, the task of the first invention is to find out a nonionic compound which can become a catalyst of high activity and easy handling, for use in a reaction between an epoxy compound and a carboxylic acid ester, a carboxylic acid anhydride, a sulfonic acid ester or a carbonic acid ester and, using the catalyst, to provide an effective process for producing an oxyalkylene derivative at a high yield.

The task of the second invention is to find out a curing accelerator having sufficient curability and further having an ordinary skeleton, to be used when an esterified phenol resin is used as a curing agent for epoxy resin and, using the curing accelerator, to provide a curing material and a semiconductor device.

The present inventors made an intensive study in order to achieve the first task and, as a result, found out that a special phosphine compound having particular substituents shows a high catalytic activity to a reaction between an epoxy compound and a carboxylic acid ester, a carboxylic acid anhydride, a sulfonic acid ester or a carbonic acid ester and an oxyalkylene derivative can be obtained at a very high yield. The first invention has been completed based on the above finding.

The first invention has the following constitution.

(1-1) A process for producing an organic compound, characterized by conducting an organic reaction in the presence of a phosphine compound represented by the following formula (1).

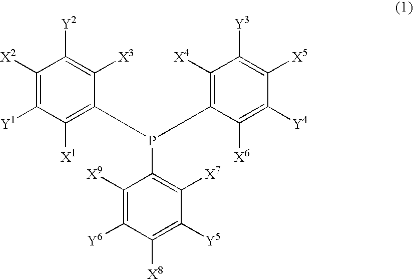

[in the above formula, X¹ to X⁹ and Y¹ to Y⁶ are each independently a hydrogen atom, an aliphatic or alicyclic hydrocarbon group of 1 to 10 carbon atoms, an aromatic hydrocarbon group of 6 to 10 carbon atoms, an alkoxy group of 1 to 10 carbon atoms, or an aryloxy group of 6 to 10 carbon atoms, with a proviso that at least three of X¹ to X⁹ are an alkoxy group of 1 to 10 carbon atoms].

(1-2) A process for producing an organic compound according to the above (1-1), characterized in that the organic reaction conducted in the presence of a phosphine compound represented by the formula (1) is a reaction an epoxy compound with an carboxylic acid ester represented by the following formula (2), a carboxylic acid anhydride represented by the following formula (3), a sulfonic acid ester represented by the following formula (4), or a carbonic acid ester represented by the following formula (5).

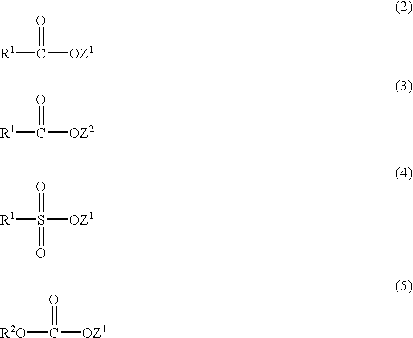

[in the formulas (2) to (5), R¹ is a hydrogen atom or an organic group containing 1 to 35 carbon atoms; R² is an aliphatic hydrocarbon group of 1 to 35 carbon atoms, or an aromatic hydrocarbon group of 6 to 35 carbon atoms; OZ¹ is an organic group formed by elimination of active hydrogen from an alcohol or a phenol; and OZ² is an organic group formed by elimination of active hydrogen from a carboxylic acid].

(1-3) A process for producing an organic compound according to the above (1-1) and (1-2), wherein in the phosphine compound represented by the formula (1), at least three of the X¹ to X⁹ are a methoxy group and remainders are each independently selected from a hydrogen atom, a methyl group and a methoxy group.

(1-4) A process for producing an organic compound according to the above (1-1) to (1-3), wherein in the phosphine compound represented by the formula (1), Y¹ to Y⁶ are each independently selected from a hydrogen atom, a methyl group and a methoxy group.

(1-5) A process for producing an organic compound according to the above (1-1) to (1-2), wherein the phosphine compound represented by the formula (1) is any of tris(2,4-dimethoxyphenyl)phosphine, tris(2,6-dimethoxyphenyl)phosphine and tris(2,4,6-trimethoxyphenyl)phosphine.

(1-6) A process for producing an organic compound according to the above (1-2) to (1-5), wherein the epoxy compound is an aliphatic, alicyclic or aromatic epoxy compound consisting of carbon atom, hydrogen atom and oxygen atom of epoxy group, or an aliphatic, alicyclic or aromatic epoxy compound having ether linkage.

(1-7) A process for producing an organic compound according to the above (1-2) to (1-6), wherein the R¹ of the formulas (2) to (4) is an alkyl group of 1 to 35 carbon atoms, an alkenyl group of 2 to 35 carbon atoms, an aryl group of 6 to 35 carbon atoms, an aliphatic hydrocarbon group containing 3 to 35 carbon atoms and having one or more carboxylic acid ester groups, an aromatic hydrocarbon group containing 8 to 35 carbon atoms and having one or more carboxylic acid ester groups, or an aromatic hydrocarbon group containing 8 to 35 carbon atoms and having one or more carboxylic acid anhydride groups.

(1-8) A process for producing an organic compound according to the above (1-2) to (1-7), wherein the OZ¹ of the formulas (2), (4) and (5) is an organic group derived from an aliphatic alcohol consisting of carbon atom, hydrogen atom and oxygen atom of alcoholic hydroxyl group, an aliphatic alcohol having ether linkage, a phenol consisting of carbon atom, hydrogen atom and oxygen atom of phenolic hydroxyl group, or a halogen atom-containing phenol.

(1-9) A process for producing an organic compound according to the above (1-2) to (1-7), wherein the OZ² of the formula (3) is an organic group derived from an aliphatic or aromatic carboxylic acid consisting of carbon atom, hydrogen atom and oxygen atom of carboxyl group.

(1-10) A process for producing an organic compound according to the above (1 -2) to (1-6) and (1-8), wherein the R² of the formula (5) is an alkyl group of 1 to 35 carbon atoms or an aromatic hydrocarbon group of 6 to 12 carbon atoms.

(1-11) A process for producing an organic compound according to the above (1 -2) to (1-8), wherein in the carboxylic acid ester represented by the formula (2), R¹ is an alkyl group of 1 to 6 carbon atoms, an alkenyl group of 2 to 4 carbon atoms, an aryl group of 6 to 10 carbon atoms, an aliphatic hydrocarbon group containing 3 to 13 carbon atoms and having one or more carboxylic acid ester groups, or an aromatic hydrocarbon group containing 8 to 16 carbon atoms and having one or more carboxylic acid ester groups; and OZ¹ is an organic group derived from an aliphatic alcohol of 1 to 20 carbon atoms consisting of carbon atom, hydrogen atom and oxygen atom of alcoholic hydroxyl group or a phenol of 6 to 27 carbon atoms consisting of carbon atom, hydrogen atom and oxygen atom of phenolic hydroxyl group.

Also, the present inventors made an intensive study in order to achieve the above second task and, as a result, found out that a triarylphosphine having particular substituents are specifically effective to a curing reaction between an epoxy resin and an esterified phenol resin. The second invention has been completed based on the above finding.

The difference between the above-mentioned JP-A-62-53327 and the second invention lies in that while the former provides no curing accelerator useful for semiconductor-encapsulating material, the second invention reveals that a triarylphosphine having particular substituents at particular positions shows a sufficient curing activity.

The difference between JP-A-8-143642, JP-A-9-235451, etc. and the present application lies in that while in the JP-A-8-143642, JP-A-9-235451, etc., conventional general-purpose curing accelerators such as phosphine type compounds, imidazole compounds and diazabicyclo type compounds are descried to be usable widely, the second invention reveals as mentioned previously that only a triarylphosphine containing, as a skeleton, aryl groups having an electron-donating group(s) at a particular position(s) can allow a reaction between epoxy group and ester group to proceed specifically at a practical efficiency.

Thus, the JP-A-8-143642, JP-A-9-235451, etc. do not show an epoxy-ester curing reaction substantially and relate to an epoxy resin composition wherein a curing reaction of epoxy resin caused by partially remaining hydroxyl group is to be conducted.

Then, description is made on the constitution of the second invention.

(2-1) An epoxy resin composition containing

(A) an epoxy compound having two or more functions or an epoxy resin having two or more functions,

(B) a curing agent which is an ester group-containing compound or an ester group-containing resin formed by acylating the hydroxyl group of a phenol compound having two or more functions or a phenol resin having two or more functions, and

(C) a curing accelerator,

characterized in that 30 to 100% by weight of the total curing accelerator (C) contains essentially a phosphine compound represented by the following formula (1).

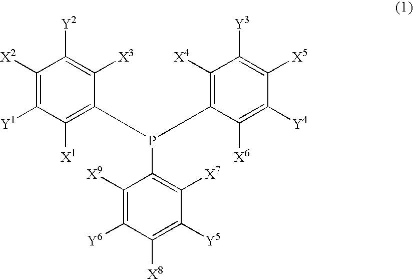

[in the formula (1), X¹ to X⁹ and Y¹ to Y⁶ are each independently a hydrogen atom, an aliphatic or alicyclic hydrocarbon group of 1 to 10 carbon atoms, an aromatic hydrocarbon group of 6 to 10 carbon atoms, an alkoxy gorup of 1 to 10 carbon atoms, or an aryloxy group of 6 to 10 carbon atoms, with a proviso that at least three of X¹ to X⁹ are an alkoxy group of 1 to 10 carbon atoms].

(2-2) An epoxy resin composition containing

(A) an epoxy compound having two or more functions or an epoxy resin having two or more functions,

(B) a curing agent which is an ester group-containing compound or an ester group-containing resin formed by acylating the hydroxyl group of a phenol compound having two or more functions or a phenol resin having two or more functions, and

(C) a curing accelerator,

characterized in that 30 to 100% by weight of the total curing accelerator (C) contains essentially a phosphine compound represented by the following formula (1).

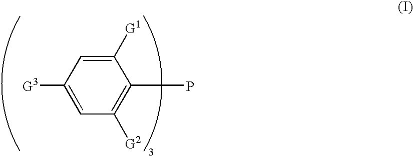

[in the above formula, G¹ to G³ are each independently a hydrogen atom and an alkoxy group of 1 to 6 carbon atoms, with a proviso that G¹ and G² are not a hydrogen atom simultaneously].

Incidentally, as the curing agent (B) which is an ester group-containing compound or an ester group-containing resin formed by acylating the hydroxyl group of a phenol compound having two or more functions or a phenol resin having two or more functions, there can be shown ester-containing compounds or ester-containing resins represented by the following general formula (II).

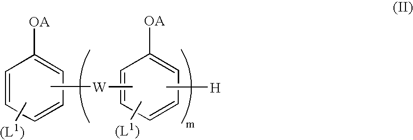

[in the formula (II), W is an aliphatic or aromatic aldehyde residue of 1 to 7 carbon atoms, a xylylene derivative residue of 8 to 14 carbon atoms, or an aliphatic diene residue of 10 to 15 carbon atoms; L¹s are an hydrogen atom, a umbrached, branched or cyclic alkyl group, an aryl group or an alkoxy group; n is an integer of 1 to 3; As are a hydrogen atom or an aromatic and/or aliphatic acyl group of 2 to 10 carbon atoms, with a proviso that the molar ratio of hydrogen atom/acyl group is in a range of 90/10 to 0/100; m which is a number of repeating unit, is in a range of 1 to 50 with the average being in a range of 1 to 20].

(2-3) An epoxy resin composition according to the above (2-1) to (2-2), wherein the phosphine compound represented by the formula (1) or the general formula (I) is tris(2,4-dimethoxyphenyl)phosphine, tris(2,6-dimethoxyphenyl)phosphine or tris(2,4,6-trimethoxyphenyl)phosphine.

(2-4) An epoxy resin composition according to the above (2-1) to (2-3), wherein the epoxy resin (A) contains therein any of the following epoxy resins as an essential component in an amount of 20 to 100% by weight:

an epoxy resin obtained from a dihydroxynaphthalene represented by the following general formula (III):

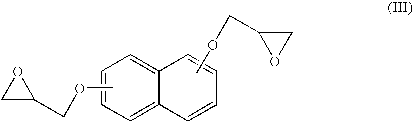

[in the formula (III), the substitution positions of 2,3-epoxypropyl group are 1 and 5 positions, 1 and 6 positions, 1 and 7 position, 2 and 6 positions or 2 and 7 positions],

an epoxy resin obtained from a biphenol represented by the following general formula (IV):

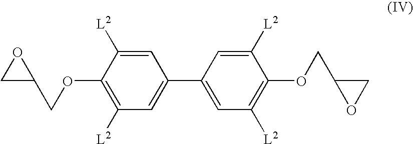

[in the formula (IV), L²s are a hydrogen atom or a methyl group and may be the same or different],

an epoxy resin obtained from a novolac type resin represented by the following general formula (V):

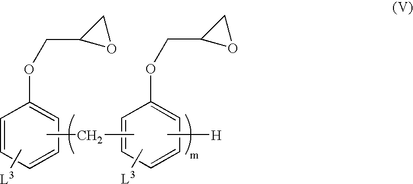

[in the formula (V), L³s are a hydrogen atom or a methyl group; and m which is a number of repeating unit, is in a range of 1 to 50 with the average being in a range of 1 to 20],

an epoxy resin obtained from a phenol aralkyl resin represented by the following general formula (VI):

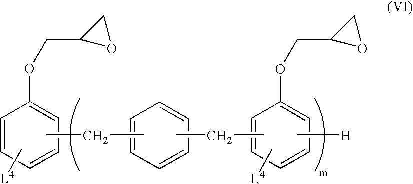

[in the formula (VI), L⁴s are a hydrogen atom or a methyl group; and m which is a number of repeating unit, is in a range of 1 to 50 with the average being in a range of 1 to 20], or

an epoxy resin obtained from a phenol-dicyclopentadiene resin represented by the following general formula (VII):

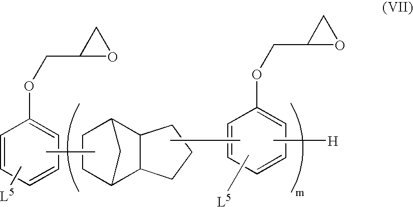

[in the formula (VII), L⁵s are a hydrogen atom or a methyl group; and m which is a number of repeating unit, is in a range of 1 to 50 with the average being in a range of 1 to 20].

(2-5) An epoxy resin composition according to the above (2-1) to (2-4), wherein 20 to 100% by weight of the curing agent component (B) is

an ester-containing compound or an ester-containing resin derived from a novolac type resin represented by the following general formula (VIII):

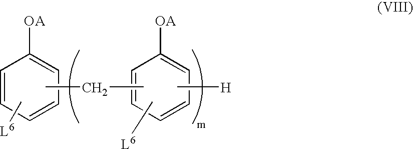

[in the formula (VIII), L⁶s are a hydrogen atom, a umbranched, branched or cyclic alkyl group of 1 to 6 carbon atoms, an aryl group or an alkoxy group; As are a hydrogen atom or an aromatic and/or aliphatic acyl group of 2 to 10 carbon atoms with a proviso that the molar ratio of hydrogen atom/acyl group is in a range of 90/10 to 0/100; and m which is a number of repeating unit, is in a range of 1 to 50 with the average being in a range of 1 to 20],

an ester-containing compound or an ester-containing resin derived from a phenol aralkyl resin represented by the following general formula (IX):

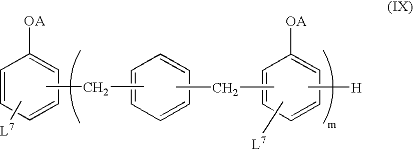

[in the formula (IX), L⁷s are a hydrogen atom, a umbranched, branched or cyclic alkyl group of 1 to 6 carbon atoms, an aryl group or an alkoxy group; As are a hydrogen atom or an aromatic and/or aliphatic acyl group of 2 to 10 carbon atoms with a proviso that the molar ratio of hydrogen atom/acyl group is in a range of 90/10 to 0/100; and m which is a number of repeating unit, is in a range of 1 to 50 with the average being in a range of 1 to 20], or

an ester-containing compound or an ester-containing resin derived from a phenol-dicyclopentadiene resin represented by the following general formula (X):

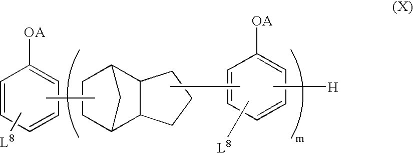

[in the formula (X), L⁸s are a hydrogen atom, a umbranched, branched or cyclic alkyl group of 1 to 6 carbon atoms, an aryl group or an alkoxy group; As are a hydrogen atom or an aromatic and/or aliphatic acyl group of 2 to 10 carbon atoms with a proviso that the molar ratio of hydrogen atom/acyl group is in a range of 90/10 to 0/100; and m which is a number of repeating unit, is in a range of 1 to 50 with the average being in a range of 1 to 20].

(2-6) An epoxy resin composition according to the above (2-1) to (2-5), wherein the acyl group of the ester group-containing compound or the ester group-containing resin formed by acylating the hydroxyl group of a phenol compound having two or more functions or a phenol resin having two or more functions is an acetyl group or a benzoyl group.

(2-7) An epoxy resin composition according to the above (2-1) to (2-5), wherein the acyl group of the ester group-containing compound or the ester group-containing resin formed by acylating the hydroxyl group of a phenolic compound having two or more functions or a phenol resin having two or more functions is an acetyl group and a benzoyl group, and the molar ratio of the acetyl group/the benzoyl group is in a range of 99/1 to 1/99.

(2-8) An epoxy resin composition according to the above (2-1) to (2-7), which further contains

(D) an organic and/or inorganic filler

in an amount of 100 to 1,900 parts by weight relative to 100 parts by weight of a total of (A) the epoxy compound having two or more functions or the epoxy resin having two ore more functions and (B) the curing agent.

(2-9) An epoxy resin cured material obtained by thermosetting an epoxy resin composition set forth in the above (2-1) to (2-8).

(2-10) A semiconductor device obtained by encapsulating a semiconductor integrated circuit using an epoxy resin composition set forth in the above (2-1) to (2-8).

### BEST MODE FOR CARRYING OUT THE INVENTION

Firstly, description is made on the first invention.

In the process of the first invention, the organic reaction conducted in the presence of a phosphine compound represented by the formula (1) is a low-molecular compound synthesis reaction or a high-molecular compound synthesis reaction between organic compounds of same kinds excluding the phosphine compound represented by the formula (1) or between an organic compound excluding the phosphine compound represented by the formula (1) and an organic compound of different kind excluding the phosphine compound represented by the formula (1). The organic compound produced includes ordinary low-molecular compound synthesis reaction products and polymers.

In the phosphine compound represented by the formula (1), X¹ to X⁹ and Y¹ to Y⁶ are each independently a hydrogen atom, an aliphatic or alicyclic hydrocarbon group of 1 to 10 carbon atoms, an aromatic hydrocarbon group of 6 to 10 carbon atoms, an alkoxy group of 1 to 10 carbon atoms, or an aryloxy group of 6 to 10 carbon atoms. Specifically, X¹ to X⁹ are selected from hydrogen atom; aliphatic or alicyclic hydrocarbon groups such as methyl, ethyl, vinyl, n-propyl, isopropyl, isopropenyl, allyl, n-butyl, sec-butyl, tert-butyl, 2-butenyl, 1-pentyl, 2-pentyl, 3-pentyl, 2-methyl-1-butyl, isopentyl, tert-pentyl, 3-methyl-2-butyl, neopentyl, n-hexyl, 4-methyl-2-pentyl, cyclopentyl, cyclohexyl, 1-heptyl, 3-heptyl, 1-octyl, 2-octyl, 2-ethyl-1-hexyl, 1,1-dimethyl-3,3-dimethylbutyl (commonly, tert-octyl), nonyl, decyl and the like; aromatic hydrocarbon groups such as phenyl, 4-toluyl, benzyl, 1-phenylethyl, 2-phenylethyl and the like; alkoxy groups of 1 to 10 carbon atoms such as methoxy, ethoxy, n-propoxy, isopropoxy, allyloxy, n-butoxy, sec-butoxy, tert-butoxy, 2-butenoxy, 1-pentyloxy, 2-pentyloxy, 3-pentyloxy, 2-methyl-1-butoxy, isopentyloxy, tert-pentyloxy, 3-methyl-2-butoxy, neopentyloxy, n-hexyloxy, 4-methyl-2-pentyloxy, cyclopentyloxy, 1-heptyloxy, 3-heptyloxy, 1-octyloxy, 2-octyloxy, 2-ethyl-1-hexyloxy, 1,1-dimethyl-3,3-dimethylbutoxy (commonly, tert-octyloxy), nonyloxy, decyloxy and the like; and aryloxy groups of 6 to 10 carbon atoms such as phenoxy, 4-tolyloxy, benzyloxy, 1-phenylethoxy, 2-phenylethoxy and the like. Of these, preferred are hydrogen atom; aliphatic hydrocarbons of 1 to 8 carbon atoms such as methyl, ethyl, n-propyl, isopropyl, tert-butyl, tert-pentyl, 1,1-dimethyl-3,3-dimethylbutyl and the like; alkoxy groups of 1 to 8 carbon atoms such as methoxy, ethoxy, n-propoxy, isopropoxy, tert-butoxy, tert-pentyloxy, 1,1-dimethyl-3,3-dimethylbutoxy and the like; and aryloxy groups of 6 to 8 carbon atoms such as phenoxy, benzyloxy and the like. More preferred are hydrogen atom, methyl group, ethyl group, methoxy group and ethoxy group.

In the phosphine compound represented by the formula (1), at least three of X¹ to X⁹ are selected from alkoxy groups of 1 to 10 carbon atoms such as illustrated above. The number of alkoxy groups of X¹ to X⁹ is preferably as large as possible and more preferably six or more. Specific examples of the phosphine compound of formula (1) are tris(2,4-dimethoxyphenyl)phosphine, tris(2,6-dimethoxyphenyl)phosphine, tris(2,6-dimethoxy-4-methylphenyl)phosphine, tris(2,6-dimethoxy-4-ethylphenyl)phosphine, tris(2,4,6-trimethoxyphenyl)phosphine, tris(2,4-diethoxyphenyl)phosphine, tris(2,6-diethoxyphenyl)phosphine, tris(2,6-diethoxy-4-methylphenyl)phosphine, tris(2,6-diethoxy-4-ethylphenyl)phosphine, tris(2,4,6-triethoxyphenyl)phosphine, tris(2,4-dimethoxy-3,5,6-trimethylphenyl)phosphine, tris(2,6-dimethoxy-3,4,5-trimethylphenyl)phosphine, tris(2,4,6-trimethoxy-3,5-dimethylphenyl)phosphine, tris(2,4-diethoxy-3,5,6-trimethylphenyl)phosphine, tris(2,6-diethoxy-3,4,5-trimethylphenyl)phosphine, tris(2,4,6-triethoxy-3,5-dimethylphenyl)phosphine, tris(2,3,5,6-tetramethoxyphenyl)phosphine, tris(2,3,5,6-tetramethoxy-4-methylphenyl)phosphine, tris(2,3,4,5,6-pentamethoxyphenyl)phosphine, tris(2,3,5,6-tetraethoxyphenyl)phosphine, tris(2,3,5,6-tetraethoxy-4-methylphenyl)phosphine, tris(2,3,4,5,6-pentaethoxyphenyl)phosphine and the like. Of these, particularly preferred are tris(2,4-dimethoxyphenyl)phosphine, tris(2,6-dimethoxyphenyl)phosphine and tris(2,4,6-trimethoxyphenyl)phosphine. These phosphine compounds represented by the formula (1) may be used singly or in a combination.

These phosphine compounds represented by the formula (1) can be synthesized by processes described in, for example, Masanori Wada, Shogo Higashizaki, Journal of the Chemical Society, Chemical Communications, p. 482, 1984, and Masanori Wada, Shogo Higashizaki, Aki Tsuboi, Journal of Chemical Research (M), p. 467, 1985, and also by processes similar thereto.

In the first invention, the epoxy compound is an organic compound having three-membered ring epoxy group. As specific examples thereof, there are mentioned aliphatic, alicyclic or aromatic epoxy compounds consisting of carbon atom, hydrogen atom and oxygen atom of epoxy group, such as ethylene oxide, propylene oxide, 1,2-epoxybutane, 2,3-epoxybutane, 1,2-epoxyhexane, 1,2-epoxyoctane, 1,2-epoxydecane, 1,2-epoxydodecane, 1,2-epoxytetradecane, 1,2-epoxyhexadecane, 1,2-epoxyoctadecane, 7,8-epoxy-2-methyloctadecane, vinyloxirane, 2-methyl-2-vinyloxirane, 1,2-epoxy-5-hexene, 1,2-epoxy-7-octene, 1-phenyl-2,3-epoxypropane, 1-(1-naphthyl)-2,3-epoxypropane, 1-cyclohexyl-3,4-epoxybutane, 1,3-butadiene dioxide, 1,2,7,8-diepoxyoctane, cyclopentene oxide, 3-methyl-1,2-cyclopentene oxide, cyclohexene oxide, cyclooctene oxide, α-pinene oxide, 2,3-epoxynorbornane, limonene oxide, cyclododecane epoxide, 2,3,5,6-diepoxynorbornane, styrene oxide, 3-methylstyrene oxide, 1,2-epoxybutylbenzene, 1,2-epoxyoctylbenzene, stilbene oxide, 3-vinylstyrene oxide, 1-(1-methyl-1,2-epoxyethyl)-3-(i-methylvinyl)benzene, 1,4-di(1,2-epoxypropyl)benzene, 1,3-di(1-methyl-1,2-epoxyethyl)benzene, 1,4-di(1-methyl-1,2-epoxyethyl)benzene and the like; halogen atom-containing aliphatic, alicyclic or aromatic epoxy compounds such as epifluorohydrin, epichlorohydrin, epibromohydrin, hexafluoropropylene oxide, 1,2-epoxy-4-fluorobutane, 1-(2,3-epoxypropyl)-4-fluorobenzene, 1-(3,4-epoxybutyl)-2-fluorobenzene, 1-(2,3-epoxypropyl)-4-chlorobenzene, 1-(3,4-epoxybutyl)-3-chlorobenzene, 4-fluoro-1,2-cyclohexene oxide, 6-chloro-2,3-epoxybicyclo[2.2.1]heptane, 4-fluorostyrene oxide, 1-(1,2-epoxypropyl)-3-trifluorobenzene and the like; keto group-containing aliphatic, alicyclic or aromatic epoxy compounds such as 3-acetyl-1,2-epoxypropane, 4-benzoyl-1,2-epoxybutane, 4-(4-benzoyl)phenyl-1,2-epoxybutane, 4,4′-di(3,4-epoxybutyl)benzophenone, 3,4-epoxy-1-cyclohexanone, 2,3-epoxy-5-oxobicyclo[2.2.1]heptane, 3-acetylstyrene oxide, 4-(1,2-epoxypropyl)benzophenone and the like; ether linkage-containing aliphatic, alicyclic or aromatic epoxy compounds such as glycidyl methyl ether, butyl glycidyl ether, 2-ethylhexyl glycidyl ether, allyl glycidyl ether, ethyl 3,4-epoxybutyl ether, glycidyl phenyl ether, glycidyl 4-tert-butylphenyl ether, glycidyl 4-chlorophenyl ether, glycidyl 4-methoxyphenyl ether, glycidyl 2-phenylphenyl ether, glycidyl 1-naphthyl ether, glycidyl 4-indolyl ether, glycidyl N-methyl-α-quinolone-4-yl ether, ethylene glycol diglycidyl ether, 1,4-butanediol diglycidyl ether, 1,2-diglycidyloxybenzene, 2,2-bis(4-glycidyloxyphenyl)propane, tris(4-glycidyloxyphenyl)methane, poly(oxypropylene)triol triglycidyl ether, glycidyl ether of phenol novolac, 1,2-epoxy-4-methoxycyclohexane, 2,3-epoxy-5,6-dimethoxybicyclo[2.2.1]heptane, 4-methoxystyrene oxide, 1-(1,2-epoxybutyl)-2-phenoxybenzene and the like; ester linkage-containing aliphatic, alicyclic or aromatic epoxy compounds such as glycidyl formate, glycidyl acetate, 2,3-epoxybutyl acetate, glycidyl butyrate, glycidyl benzoate, diglycidyl terephthalate, poly(glycidyl methacrylate), 1,2-epoxy-4-methoxycarbonylcyclohexane, 2,3-epoxy-5-butoxycarbonylbicyclo[2.2.1]heptane, ethyl 4-(1,2-epoxyethyl)benzoate, methyl 3-(1,2-epoxybutyl)benzoate, methyl 3-(1,2-epoxybutyl)-5-phenylbenzoate and the like; amide linkage-containing aliphatic, alicyclic or aromatic epoxy compounds such as N,N-glycidylmethylacetamide, N,N-ethylglycidylpropionamide, N,N-glycidylmethylbenzamide, N-(4,5-epoxypentyl)-N-methylbenzamide, poly(N-glycidylacrylamide), poly(N,N-glycidylmethylacrylamide), 1,2-epoxy-3-(diphenylcarbamoyl)cyclohexane, 2,3-epoxy-6-(dimethylcarbamoyl)bicyclo[2.2.1]heptane, 2-(dimethylcarbamoyl)styrene oxide, 4-(1,2-epoxybutyl)-4′-(dimethylcarbamoyl)biphenyl and the like; and cyano group-containing aliphatic, alicyclic or aromatic epoxy compounds such as 4-cyano-1,2-epoxybutane, 1-(3-cyanophenyl)-2,3-epoxybutane, 5-cyano-2,3-epoxybicyclo[2.2.1]heptane, 2-cyanostyrene oxide, 6-cyano-1-(1,2-epoxy-2-phenylethyl)naphthalene and the like. These compounds may have any other substituents as long as the process of the first invention is not impaired thereby. These epoxy compounds are preferably used singly but may also be used in combinations of two or more kinds.

Of these, preferred are aliphatic, alicyclic or aromatic epoxy compounds consisting of carbon atom, hydrogen atom and oxygen atom of epoxy group, such as ethylene oxide, propylene oxide, 1,2-epoxybutane, 2,3-epoxybutane, 1,2-epoxyhexane, 1,2-epoxyoctane, 1,2-epoxydecane, 1,2-epoxydodecane, 1,2-epoxytetradecane, 1,2-epoxyhexadecane, 1,2-epoxyoctadecane, 7,8-epoxy-2-methyloctadecane, vinyloxirane, 2-methyl-2-vinyloxirane, 1,2-epoxy-5-hexene, 1,2-epoxy-7-octene, 1-phenyl-2,3-epoxypropane, 1-(1-naphthyl)-2,3-epoxypropane, 1-cyclohexyl-3,4-epoxybutane, 1,3-butadiene dioxide, 1,2,7,8-diepoxyoctane, cyclopentene oxide, 3-methyl-1,2-cyclopentene oxide, cyclohexene oxide, cyclooctene oxide, α-pinene oxide, 2,3-epoxynorbornane, limonene oxide, cyclododecane epoxide, 2,3,5,6-diepoxynorbomane, styrene oxide, 3-methylstyrene oxide, 1,2-epoxybutylbenzene, 1,2-epoxyoctylbenzene, stilbene oxide, 3-vinylstyrene oxide, 1-(1-methyl-1,2-epoxyethyl)-3-(1-methylvinyl)benzene, 1,4-di(1,2-epoxypropyl)benzene, 1,3-di(1,2-epoxy-1-methylethyl)benzene, 1,4-di(1,2-epoxy-1-methylethyl)benzene and the like; and ether linkage-containing aliphatic, alicyclic or aromatic epoxy compounds such as glycidyl methyl ether, butyl glycidyl ether, 2-ethylhexyl glycidyl ether, allyl glycidyl ether, ethyl 3,4-epoxybutyl ether, glycidyl phenyl ether, glycidyl 4-tert-butylphenyl ether, glycidyl 4-chlorophenyl ether, glycidyl 4-methoxyphenyl ether, glycidyl 2-phenylphenyl ether, glycidyl 1-naphthyl ether, glycidyl 4-indolyl ether, glycidyl N-methyl-α-quinolone-4-yl ether, ethylene glycol diglycidyl ether, 1,4-butanediol diglycidyl ether, 1,2-diglycidyloxybenzene, 2,2-bis(4-glycidyloxyphenyl)propane, tris(4-glycidyloxyphenyl)methane, poly(oxypropylene)triol triglycidyl ether, glycidyl ether of phenol novolac, 1,2-epoxy-4-methoxycyclohexane, 2,3-epoxy-5,6-dimethoxybicyclo[2.2.1]heptane, 4-methoxystyrene oxide, 1-(1,2-epoxybutyl)-2-phenoxybenzene and the like.

More preferred are aliphatic epoxy compounds of 2 to 13 carbon atoms consisting of carbon atom, hydrogen atom and oxygen atom of epoxy group, such as ethylene oxide, propylene oxide, 1,2-epoxybutane, 2,3-epoxybutane, 1,2-epoxyhexane, 1,2-epoxyoctane, 1,2-epoxydecane, 1,2-epoxydodecane, vinyloxirane, 2-methyl-2-vinyloxirane, 1,2-epoxy-5-hexene, 1,2-epoxy-7-octene, 1-phenyl-2,3-epoxypropane, 1-(1-naphthyl)-2,3-epoxypropane, 1-cyclohexyl-3,4-epoxybutane, 1,3-butadiene dioxide, 1,2,7,8-diepoxyoctane and the like; and ether linkage-containing aliphatic epoxy compounds of 4 to 21 carbon atoms, such as glycidyl methyl ether, butyl glycidyl ether, 2-ethylhexyl glycidyl ether, allyl glycidyl ether, ethyl 3,4-epoxybutyl ether, glycidyl phenyl ether, glycidyl 4-tert-butylphenyl ether, glycidyl 4-chlorophenyl ether, glycidyl 4-methoxyphenyl ether, glycidyl 2-phenylphenyl ether, glycidyl 1-naphthyl ether, glycidyl 4-indolyl ether, glycidyl N-methyl-α-quinolone-4-yl ether, ethylene glycol diglycidyl ether, 1,4-butanediol diglycidyl ether, 1,2-diglycidyloxybenzene, 2,2-bis(4-glycidyloxyphenyl)propane and the like.

In the process of the first invention, the above-mentioned epoxy compound is contacted with a carboxylic acid ester represented by the following formula (2), a carboxylic acid anhydride represented by the following formula (3), a sulfonic acid ester represented by the following formula (4) or a carbonic acid ester represented by the following formula (5), in the presence of a phosphine compound represented by the formula (1).

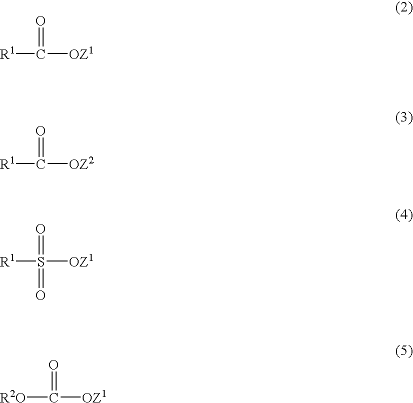

[in the formulas (2) to (5), R¹ is a hydrogen atom or an organic group containing 1 to 35 carbon atoms; R² is an aliphatic hydrocarbon group of 1 to 35 carbon atoms, or an aromatic hydrocarbon group of 6 to 35 carbon atoms; OZ¹ is an organic group formed by elimination of active hydrogen from an alcohol or a phenol; and OZ² is an organic group formed by elimination of active hydrogen from an carboxylic acid].

By the above reaction are produced, respectively, oxyalkylene derivatives having a substructure represented by the formula (6), a substructure represented by the formula (7), a substructure represented by the formula (8), or a substructure represented by the formula (9) and/or a substructure represented by the formula (10), correspondingly to the formulas (2) to (5).

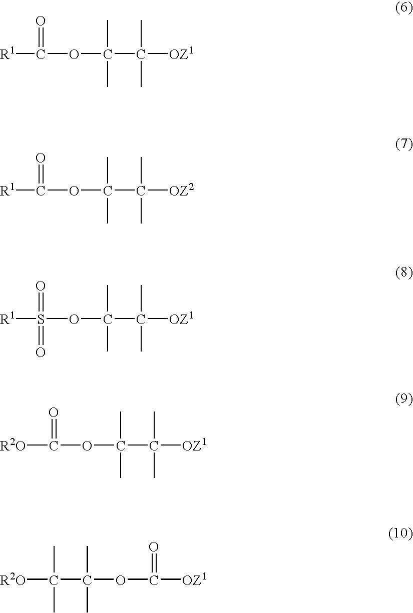

[in the formulas (6) to (10), R¹, R², OZ¹ and OZ² have the same definitions as in the formulas (2) to (5)].

That is, an epoxy compound is contacted with a carboxylic acid ester represented by the formula (2) to produce an oxyalkylene derivative having a substructure represented by the formula (6); an epoxy compound is contacted with a carboxylic acid anhydride represented by the formula (3) to produce an oxyalkylene derivative having a substructure represented by the formula (7); an epoxy compound is contacted with a sulfonic acid ester represented by the formula (4) to produce an oxyalkylene derivative having a substructure represented by the formula (8); and an epoxy compound is contacted with a carbonic acid ester represented by the formula (5) to produce an oxyalkylene derivative having a substructure represented by the formula (9) and/or the substructure represented by the formula (10).

In the process of the first invention, R¹ in the carboxylic acid ester represented by the formula (2), the carboxylic acid anhydride represented by the formula (3) and the sulfonic acid ester represented by the formula (4) is a hydrogen atom or an organic group containing 1 to 35 carbon atoms. The organic group containing 1 to 35 carbon atoms is, for example, a hydrocarbon group of 1 to 35 carbon atoms, an organic group containing 2 to 35 carbon atoms and having one or more carboxylic acid ester groups, an organic group containing 2 to 35 carbon atoms and having one or more carboxylic acid anhydride groups, or an organic group containing 3 to 35 carbon atoms and having one or more sulfonic acid ester groups.

As the hydrocarbon group of 1 to 35 carbon atoms, there can be mentioned, for example, branched or umbranched alkyl groups of 1 to 35 carbon atoms, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, hentriacontyl, dotriacontyl, tritriacontyl, pentatriacontyl and the like; cycloalkyl groups of 3 to 35 carbon atoms, such as cyclopropyl, cyclobutyl, cyclopentyl, cyclohexyl, cycloheptyl, cyclooctyl, cyclononyl, cyclodecyl, cycloundecyl, cyclododecyl, cyclotridecyl, cyclotetradecyl, cyclopentadecyl, cyclohexadecyl, cycloheptadecyl, cyclooctadecyl, cyclononadecyl, cycloeicosyl, 2,3,4,5,6,7-hexahydroindenyl, 2-norbornyl, 5-norbornen-2-yl, adamantyl and the like; branched or umbranched alkenyl groups of 2 to 35 carbon atoms, such as vinyl, isopropenyl, allyl, 1-butenyl, 2-butenyl, 3-butenyl, 1-pentenyl, 2-pentenyl, hexenyl, heptenyl, octenyl, nonenyl, decenyl, undecenyl, tridecenyl, tetradecenyl, pentadecenyl, hexadecenyl, heptadecenyl, octadecenyl, nonadecenyl, eicosenyl and the like; branched or umbranched alkynyl groups of 2 to 35 carbon atoms, such as ethynyl, propynyl, butynyl, pentynyl, hexynyl, heptynyl, octynyl, nonynyl, decynyl, undecynyl, dodecynyl, tridecynyl, tetradecynyl, pentadecynyl, hexadecynyl, heptadecynyl, octadecynyl, nonadecynyl, eicosynyl and the like; and aryl groups of 6 to 35 carbon atoms, such as phenyl, tolyl, 2-ethylphenyl, 4-tert-butylphenyl, 4-nonylphenyl, 2-cyclohexylphenyl, 4-vinylphenyl, 4-isopropenylphenyl, 3-phenylphenyl, 1-naphthyl, 2-naphthyl, 5-methyl-1-naphthayl, 6-vinyl-2-naphthyl, anthracen-1-yl, phenathren-1-yl, 1-(1-naphthyl)-2-naphthyl, 4-chlorophenyl, pentafluorophenyl, 2,6-dibromophenyl, 2,4-diiodophenyl, 5-fluoro-1-naphthyl, 6-bromo-2-naphthyl and the like.

As the organic group containing 2 to 35 carbon atoms and having one or more carboxylic acid ester groups, there can be mentioned, for example, aliphatic hydrocarbon groups containing 3 to 35 carbon atoms and having one or more carboxylic acid ester groups, such as methoxycarbonylmethyl, 2-(4-chlorophenoxycarbonyl)ethyl, 10-(methoxycarbonyl)decyl, 4-(n-octyloxycarbonyl)butyl, 2-(4-phenoxyphenoxycarbonyl)-1-methylethyl, 8-(cyclohexyloxycarbonyl)octyl, 10-(phenoxycarbonyl)decyl, 10-(n-octyloxycarbonyl)decyl, 2,3-di(1-naphthoxycarbonyl)-1-methylpropyl, 2,3,4-tri(n-nonyloxycarbonyl)butyl, 2-(methoxycarbonyl)cyclopropyl, 4-(isopropoxycarbonyl)cyclohexyl, 3-(phenoxycarbonyl)cyclopentyl, 3,5-di(ethoxycarbonyl)cyclohexyl, 4-(4-methoxycarbonylphenyl)cyclohexyl, 3-cyclohexyloxycarbonyl-bicyclo[2.2.1]heptan-2-yl, 5-(4-fluorophenoxycarbonyl)-bicyclo[2.2.1]heptan-2-yl, 5-(4-fluorophenoxycarbonyl)-bicyclo[2.2.1]heptan-3-yl, 3,4-di(4-methoxybutyloxycarbonyl)cyclohexyl, 3,5-di(n-octyloxycarbonyl)cyclohexyl, 4-(n-eicosyloxycarbonyl)cyclohexyl, 2,3,4-tri(n-nonyloxycarbonyl)cyclopentyl and the like; aromatic hydrocarbon groups containing 8 to 35 carbon atoms and having one or more carboxylic acid ester groups, such as 4-methoxycarbonylphenyl, 3-ethoxycarbonyl-5-methylphenyl, 4-(4-methoxycarbonylphenyl)phenyl, 4-(2-phenoxycarbonylvinyl)phenyl, 6-n-butoxycarbonyl-2-yl, 3,4,5-tri(ethoxycarbonyl)phenyl, 3,4-di(n-butoxycarbonyl)phenyl, 3,5-di(n-octyloxycarbonyl)phenyl, 4-[3,5-di(n-decyloxycarbonyl)phenyl]phenyl, 3,4-di(4-phenylphenyl)phenyl and the like; and substituted carboxy groups containing 2 to 35 carbon atoms, such as methoxycarbonyl, 4-ethoxybutoxycarbonyl, cyclohexyloxycarbonyl, phenoxycarbonyl, n-decyloxycarbonyl, 1-naphthoxycarbonyl, 8-benzoyloxyoctyloxycarbonyl, 1-decanoyloxymethyl-2-decanoyloxyethyloxycarbonyl and the like.

As the organic group containing 2 to 35 carbon atoms and having one or more carboxylic acid anhydride groups, there can be mentioned, for example, aliphatic hydrocarbon groups containing 3 to 35 carbon atoms and having one or more carboxylic acid anhydride groups, such as formyloxycarbonylmethyl, 2-acetoxycarbonylvinyl, tetrahydrofuran-2,5-dion-3-ylmethyl, cyclohexane-3,4-dicarboxylic acid anhydride-1-yl, bicyclo[2.2.1]heptane-2,3-dicarboxylic acid anhydride-5-yl, bicyclo[2.2.1]heptane-7-oxa-2,3-dicarboxylic acid anhydride-5-yl, 4-(n-octanoyloxycarbonyl)butyl, 10-(benzoyloxycarbonyl)decyl, 3,4-di(cyclohexyloxycarbonyl)-2-ethylbutyl, 3,4-di(decanoyloxycarbonyl)cyclohexyl, 2,3,4-tri(n-octanoyloxycarbonyl)butyl, 2,3,5-tri(n-octanoyloxycarbonyl)cyclopentyl and the like; aromatic hydrocarbon groups containing 8 to 35 carbon atoms and having one or more carboxylic acid anhydride groups, such as 4-formyloxycarbonylphenyl, anhydrous fumar-5-yl, 4-(2-n-butyloyloxycarbonylvinyl)phenyl, naphthalene-5,6-dicarboxylic acid anhydride-1-yl, 4-octanoyloxycarbonylphenyl, 6-(n-eicosanoyloxycarbonyl)-1-chloro-2-yl and the like; and substituted carbonyloxycarbonyl groups containing 2 to 35 carbon atoms, such as formyloxycarbonyl, cyclohexylcarbonyloxycarbonyl, benzoyloxycarbonyl, 1-naphthoyloxycarbonyl and the like.

As the organic group containing 3 to 35 carbon atoms and having one or more sulfonic acid ester groups, there can be mentioned, for example, 2-methoxysulfonylethyl, 4-(n-butoxysulfonyl)butyl, 4-(n-octyloxysulfonyl)cyclohexyl, 4-phenoxysulfonylphenyl, 6-(n-octyloxysulfonyl)cyclohexyl and the like.

The organic group containing 1 to 35 carbon atoms may have any substituent or hetero atom other than those mentioned above, as long as the process of the first invention is not impaired thereby.

Of these, preferred are branched or umbranched alkyl groups of 1 to 35 carbon atoms, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, hentriacontyl, dotriacontyl, tritriacontyl, pentatriacontyl and the like; branched or umbranched alkenyl groups of 2 to 35 carbon atoms, such as vinyl, isopropenyl, allyl, 1-butenyl, 2-butenyl, 3-butenyl, 1-pentenyl, 2-pentenyl, hexenyl, heptenyl, octenyl, nonenyl, decenyl, undecenyl,dodecenyl, tridecenyl, tetradecenyl, pentadecenyl, hexadecenyl, heptadecenyl, octadecenyl, nonadecenyl, eicosenyl and the like; aryl groups of 6 to 35 carbon atoms, such as phenyl, tolyl, 2-ethylphenyl, 4-tert-butylphenyl, 4-nonylphenyl, 2-cyclohexylphenyl, 4-vinylphenyl, 4-isopropenylphenyl, 3-phenylphenyl, 1-naphthyl, 2-naphthyl, 5-methyl-1-naphthayl, 6-vinyl-2-naphthyl, anthracen-1-yl, phenathren-1-yl, 1-(1-naphthyl)-2-naphthyl, 4-chlorophenyl, pentafluorophenyl, 2,6-dibromophenyl, 2,4-diiodophenyl, 5-fluoro-1-naphthyl, 6-bromo-2-naphthyl and the like; aliphatic hydrocarbon groups containing 3 to 35 carbon atoms and having one or more carboxylic acid ester groups, such as methoxycarbonylmethyl, 2-(4-chlorophenoxycarbonyl)ethyl, 10-(methoxycarbonyl)decyl, 4-(n-octyloxycarbonyl)butyl, 2-(4-phenoxyphenoxycarbonyl)-1-methylethyl, 8-(cyclohexyloxycarbonyl)octyl, 10-(phenoxycarbonyl)decyl, 10-(n-octyloxycarbonyl)decyl, 2,3-di(1-naphthoxycarbonyl)-1-methylpropyl, 2,3,4-tri(n-nonyloxycarbonyl)butyl, 2-(methoxycarbonyl)cyclopropyl, 4-(isopropoxycarbonyl)cyclohexyl, 3-(phenoxycarbonyl)cyclopentyl, 3,5-di(ethoxycarbonyl)cyclohexyl, 4-(4-methoxycarbonylphenyl)cyclohexyl, 3-cyclohexyloxycarbonyl-bicyclo[2.2.1]heptan-2-yl, 5-(4-fluorophenoxycarbonyl)-bicyclo[2.2.1]heptan-2-yl, 5-(4-fluorophenoxycarbonyl)-bicyclo[2.2.1]heptan-3-yl, 3,4-di(4-methoxybutyloxycarbonyl)cyclohexyl, 3,5-di(n-octyloxycarbonyl)cyclohexyl, 4-(n-eicosyloxycarbonyl)cyclohexyl, 2,3,4-tri(n-nonyloxycarbonyl)cyclopentyl and the like; aromatic hydrocarbon groups containing 8 to 35 carbon atoms and having one or more carboxylic acid ester groups, such as 4-methoxycarbonylphenyl, 3-ethoxycarbonyl-5-methylphenyl, 4-(4-methoxycarbonylphenyl)phenyl, 4-(2-phenoxycarbonylvinyl)phenyl, 6-n-butoxycarbonyl-2-yl, 3,4,5-tri(ethoxycarbonyl)phenyl, 3,4-di(n-butoxycarbonyl)phenyl, 3,5-di(n-octyloxycarbonyl)phenyl, 4-[3,5-di(n-decyloxycarbonyl)phenyl]phenyl, 3,4-di(4-phenylphenyl)phenyl and the like; and aromatic hydrocarbon groups containing 8 to 35 carbon atoms and having one or more carboxylic acid anhydride groups, such as 4-formyloxycarbonylphenyl, anhydrous fumar-5-yl, 4-(2-n-butyloyloxycarbonylvinyl)phenyl, naphthalene-5,6-dicarboxylic acid anhydride-1-yl, 4-octanoyloxycarbonylphenyl, 6-(n-eicosanoyloxycarbonyl)-1-chloro-2-yl and the like.

More preferred are branched or umbranched alkyl groups of 1 to 6 carbon atoms, such as methyl, ethyl, propyl, butyl, pentyl, hexyl and the like; branched or umbranched alkenyl groups of 2 to 4 carbon atoms, such as vinyl, isopropenyl, allyl, 1-butenyl, 2-butenyl, 3-butenyl and the like; aryl groups of 6 to 10 carbon atoms, such as phenyl, tolyl, 2-ethylphenyl, 4-tert-butylphenyl, 4-vinylphenyl, 4-isopropenylphenyl, 1-naphthyl, 2-naphthyl, 4-chlorophenyl, pentafluorophenyl, 2,6-dibromophenyl, 2,4-diiodophenyl, 5-fluoro-1-naphthyl, 6-bromo-2-naphthyl and the like; aliphatic hydrocarbon groups containing 3 to 13 carbon atoms and having one or more carboxylic acid ester groups, such as methoxycarbonylmethyl, 2-(4-chlorophenoxycarbonyl)ethyl, 10-(methoxycarbonyl)decyl, 4-(n-octyloxycarbonyl)butyl, 2-(methoxycarbonyl)cyclopropyl, 4-(isopropoxycarbonyl)cyclohexyl, 3-(phenoxycarbonyl)cyclopentyl, 3,5-di(ethoxycarbonyl)cyclohexyl and the like; aromatic hydrocarbon groups containing 8 to 16 carbon atoms and having one or more carboxylic acid ester groups, such as 4-methoxycarbonylphenyl, 3-ethoxycarbonyl-5-methylphenyl, 4-(4-methoxycarbonylphenyl)phenyl, 4-(2-phenoxycarbonylvinyl)phenyl, 6-n-butoxycarbonyl-2-yl, 3,4,5-tri(ethoxycarbonyl)phenyl, 3,4-di(n-butoxycarbonyl)phenyl and the like; and aromatic hydrocarbon groups containing 8 to 16 carbon atoms and having one or more carboxylic acid anhydride groups, such as 4-formyloxycarbonylphenyl, anhydrous fumar-5-yl, 4-(2-n-butyroyloxycarbonylvinyl)phenyl, naphthalene-5,6-dicarboxylic acid anhydride-1-yl, 4-octanoyloxycarbonylphenyl and the like.

In the process of the first invention, OZ¹ in the carboxylic acid ester represented by the formula (2), the sulfonic acid ester represented by the formula (3) and the carbonic acid ester represented by the formula (5) indicates an organic group formed by elimination of active hydrogen from an alcohol or a phenol.

As the alcohol from which the organic group OZ¹ is derived, there can be mentioned, for example, branched or umbranched aliphatic or alicyclic alcohols consisting of carbon atom, hydrogen atom and oxygen atom of alcoholic hydroxyl group, such as methanol, ethanol, propanol, butanol, pentanol, hexanol, heptanol, octanol, nonanol, decanol, undecanol, dodecanol, tridecanol, tetradecanol, pentadecanol, hexadecanol, heptadecanol, octadecanol, nonadecanol, eicosanol, docosanol, hexacosanol, triacontanol, allyl alcohol, 2-methyl-2-propen-1-ol, crotyl alcohol, 3-buten-1-ol, 3-methyl-2-buten-1-ol, 2-penten-1-ol, 4-methyl-3-penten-1-ol, 2-hexen-1-ol, 6-methyl-5-hepten-2-ol, 1-octen-3-ol, β-citronellol, dihydromyrcenol, oleyl alcohol, nerolidol, 1,6-pentadien-4-ol, 2,4-dimethyl-2,6-heptadien-1-ol, nerol, geraniol, linalool, 8,10-dodecadien-1-ol, farnesol, benzyl alcohol, phenethyl alcohol, diphenylpropanol, phenylbutanol, ethylene glycol, propylene glycol, glycerine, poly(vinyl alcohol), cyclobutanol, cyclopentanol, cyclohexanol, 2-methylcyclohexanol, menthol, cycloheptanol, cyclooctanol, cyclododecanol, norborneol, borneol, decahydro-1-naphthaol, 1-adamanthanol, 2-cyclohexen-1-ol, terpinen-4-ol, carveol, 5-norbornen-2-ol, ergocalciferol and the like; halogen atom-containing, branched or umbranched, aliphatic or alicyclic alcohols, such as 2-fluoroethanol, 2-chloropropanol, 3-chloro-2,2-dimethylpropanol, 6-chloro-1-hexanol, 2,2,3,3-tetrafluoropropanol, 2-chloro-2-propen-1-ol, 4-chlorobenzyl alcohol, 3-(6-chloro-1-naphthyl)propanol, 2-chlorocyclohexanol and the like; ether linkage-containing, branched or umbranched, aliphatic or alicyclic alcohols, such as 2-methoxyethanol, 1-methoxy-2-propanol, 3-cyclohexyloxy-1-propanol, diethylene glycol monomethyl ether, dipropylene glycol monomethyl ether, diethylene glycol, dipropylene glycol, triethylene glycol, poly(oxypropylene)triol, 2-ethoxybenzyl alcohol, 3-phenoxybenzyl alcohol, 6-methoxynaphthalene-2-ethanol, tetrahydro-4H-pyran-4-ol, 1,4-dioxane-2,3-diol and the like; ester linkage-containing, branched or umbranched, aliphatic or alicyclic alcohols, such as 3-acetoxy-1-propanol, 2-(3-methylbenzoyloxy)1-ethanol, 4-hydroxybutyl methacrylate, 3-acetoxycinnamic alcohol, 2-hydroxyethyl 3-(2-hydroxyethyloxy)benzoate, di(2-hydroxypropyl) succinate, 3-methoxycarbonylcyclohexanol, 4-vinyloxycarbonylcyclohexanol, di(2-hydroxyethyl) terephthalate and the like; and amide linkage-containing, branched or umbranched, aliphatic or alicyclic alcohols, such as N-(2-hydroxyethyl)acetamide, 3-(dimethylcarbamoyl)-1-propanol, N-(3-hydroxypropyl)acrylamide, N-(4-hydroxycyclohexyl)benzamide, di-N-(2-hydroxyethyl)phthalamide and the like. These compounds may have any other substituent as long as the process of the first invention is not impaqired thereby.

Of these, preferred are branched or umbranched aliphatic alcohols consisting of carbon atom, hydrogen atom and oxygen atom of alcoholic hydroxyl group, such as methanol, ethanol, propanol, butanol, pentanol, hexanol, heptanol, octanol, nonanol, decanol, undecanol, dodecanol, tridecanol, tetradecanol, pentadecanol, hexadecanol, heptadecanol, octadecanol, nonadecanol, eicosanol, docosanol, hexacosanol, triacontanol, allyl alcohol, 2-methyl-2-propen-1-ol, crotyl alcohol, 3-buten-1-ol, 3-methyl-2-buten-1-ol, 2-penten-1-ol, 4-methyl-3-penten-1-ol, 2-hexen-1-ol, 6-methyl-5-hepten-2-ol, 1-octen-3-ol, β-citronellol, dihydromyrcenol, oleyl alcohol, nerolidol, 1,6-pentadien-4-ol, 2,4-dimethyl-2,6-heptadien-1-ol, nerol, geraniol, linalool, phenethyl alcohol, diphenylpropanol, phenylbutanol, ethylene glycol, propylene glycol, glycerine, poly(vinyl alcohol) and the like; and ether linkage-containing, branched or umbranched, aliphatic or alicyclic alcohols, such as 2-methoxyethanol, 1-methoxy-2-propanol, 3-cyclohexyloxy-1-propanol, diethylene glycol monomethyl ether, dipropylene glycol monomethyl ether, diethylene glycol, dipropylene glycol, triethylene glycol, poly(oxypropylene)triol, 2-ethoxybenzyl alcohol, 3-phenoxybenzyl alcohol, 6-methoxynaphthalene-2-ethanol and the like.

More preferred are branched or umbranched aliphatic alcohols of 1 to 20 carbon atoms consisting of carbon atom, hydrogen atom and oxygen atom of alcoholic hydroxyl group, such as methanol, ethanol, propanol, butanol, pentanol, hexanol, heptanol, octanol, nonanol, decanol, undecanol, dodecanol, tridecanol, tetradecanol, pentadecanol, hexadecanol, heptadecanol, octadecanol, nonadecanol, eicosanol, allyl alcohol, 2-methyl-2-propen-1-ol, crotyl alcohol, 3-buten-1-ol, 3-methyl-2-buten-1-ol, 2-penten-1-ol, 4-methyl-3-penten-1-ol, 2-hexen-1-ol, 6-methyl-5-hepten-2-ol, 1-octen-3-ol, 1,6-pentadien-4-ol, 2,4-dimethyl-2,6-heptadien-1-ol, nerol, geraniol, linalool, 8,10-dodecadien-1-ol, farnesol, benzyl alcohol, phenethyl alcohol, diphenylpropanol, phenylbutanol, ethylene glycol, propylene glycol, glycerine and the like.

As the phenol from which the organic group OZ¹ is derived, there can be mentioned, for example, phenols consisting of carbon atom, hydrogen atom and oxygen atom of phenolic hydroxyl group, such as phenol, cresol, 3-isopropylphenol, 4-butylphenol, 2-cyclopentylphenol, 2,3-dimethylphenol, 2,3,6-trimethylphenol, 2,6-diisopropylphenol, 3,5-di-tert-butylphenol, 2,6-di-tert-butyl-4-methylphenol, 5-indanol, 5,6,7,8-tetrahydro-1-naphthol, naphthol, nonylphenol, 4-hydroxystyrene, 4-hydroxy-α-methylstyrene, 1,1′-bi(2-naphthol), catechol, resorcinol, hydroquinone, 2-methylresorcinol, 4-hexylresorcinol, 2,6-dihydroxynaphthalene, bis(4-hydroxyphenyl)methane, 2,2-bis(4-hydroxyphenyl)propane, 2,2-bis(4-hydroxy-3-methylphenyl)propane, 2,2′-biphenol, 4,4′-biphenol, phenylhydroquinone, 1,3,5-trihydroxybenzene, 2,4-di(4-hydroxyphenyl)-4-methyl-1-pentene, 2,4,6-tri(4-hydroxyphenyl)-2,6-dimethyl-3-hexene, 5-hydroxy-3-(4-hydroxyphenyl)-1,1,3-trimethyl-2,3-dihydroindene, 5-hydroxy-3-(4-hydroxyphenyl)-2,6-dimethyl-3-hexene, tri(4-hydroxyphenyl)methane, phenol novolac, poly(4-hydroxystyrene). poly(4-hydroxy-α-methylstyrene) and the like; halogen atom-containing phenols, such as 3-fluorophenol, 2-trifluoromethylphenol, 4-chlorophenol, 2-bromophenol, 2,6-difluorophenol, 4-fluoro-2-methylphenol, 2,3,4-trichlorophenol, 2,2-bis(4-hydroxy-3,5-dichlorophenyl)propane, 2,2-bis(4-hydroxyphenyl)-1,1,1,3,3,3-hexafluoropropane, octafluoro-4,4′-biphenol, 6,6′-dibromo-1,1′-bi-2-naphthol and the like; ether linkage-containing phenols, such as 2-ethoxyphenol, 4-(phenoxymethyl)phenol, 3,4,5-trimethoxyphenol, 7-methoxy-2-naphthol, 4-benzyloxy-3-methoxyphenol, 3,3′-(ethylenedioxy)diphenol and the like; keto group-containing phenols, such as 3-hydroxyacetophenone, 2-(2-oxopropyl)phenol, 4-hydroxybenzophenone, 1-hydroxy-2-acenaphthone, 4,4′-dihydroxybenzophenone, 2,6-dihydroxyacetophenone, phloretin and the like; ester linkage-containing phenols, such as 4-acetoxymethylphenol, methyl salicylate, 4-hydroxybenzyl acrylate, ethyl 4-hydroxy-3-methoxycinnamate, 2-methoxycarbonyl-6-methyl-3-naphthol, 1,2-di(4-hydroxybenzoyloxy)ethane, ethyl 3,4,5-trihydroxybenzoate and the like; and amide linkage-containing phenols, such as 4-acetoaminophenol, 3-(N,N-dimethylcarbamoyl)phenol, 4-(N,N-dimethylcarbamoyl)-3-methylphenol, N-(3-hydroxy-5-methyl)phenylacrylamide, N-(5-hydroxy-8-methyl-2-naphthyl)methacrylamide, N-(4-hydroxybenzyl)benzamide, N,N′-di(4-hydroxyphenyl)-5-methyl-1,3-benzenedicarboxylic acid amide and the like. These may have any other substituent as long as the process of the first invention is not impaired thereby.

Of these, preferred are phenols consisting of carbon atom, hydrogen atom and oxygen atom of phenolic hydroxyl group, such as phenol, cresol, 3-isopropylphenol, 4-butylphenol, 2-cyclopentylphenol, 2,3-dimethylphenol, 2,3,6-trimethylphenol, 2,6-diisopropylphenol, 3,5-di-tert-butylphenol, 2,6-di-tert-butyl-4-methylphenol, 5-indanol, 5,6,7,8-tetrahydro-1-naphthol, naphthol, nonylphenol, 4-hydroxystyrene, 4-hydroxy-α-methylstyrene, 1,1 ′-bi(2-naphthol), catechol, resorcinol, hydroquinone, 2-methylresorcinol, 4-hexylresorcinol, 2,6-dihydroxynaphthalene, bis(4-hydroxyphenyl)methane, 2,2-bis(4-hydroxyphenyl)propane, 2,2-bis(4-hydroxy-3-methylphenyl)propane, 2,2′-biphenol, 4,4′-biphenol, phenylhydroquinone, 1,3,5-trihydroxybenzene, 2,4-di(4-hydroxyphenyl)-4-methyl-1-pentene, 2,4,6-tri(4-hydroxyphenyl)-2,6-dimethyl-3-hexene, 5-hydroxy-3-(4-hydroxyphenyl)-1,1,3-trimethyl-2,3-dihydroindene, 5-hydroxy-3-(4-hydroxyphenyl)-2,6-dimethyl-3-hexene, tri(4-hydroxyphenyl)methane, phenol novolac, poly(4-hydroxystyrene), poly(4-hydroxy-α-methylstyrene) and the like; and halogen atom-containing phenols, such as 3-fluorophenol, 2-trifluoromethylphenol, 4-chlorophenol, 2-bromophenol, 2,6-difluorophenol, 4-fluoro-2-methylphenol, 2,3,4-trichlorophenol, 2,2-bis(4-hydroxy-3,5-dichlorophenyl)propane, 2,2-bis(4-hydroxyphenyl)-1,1,1,3,3,3-hexafluoropropane, octafluoro-4,4′-biphenol, 6,6′-dibromo-1,1′-bi-2-naphthol and the like.

More preferred are phenols of 6 to 27 carbon atoms consisting of carbon atom, hydrogen atom and oxygen atom of phenolic hydroxyl group, such as phenol, cresol, 3-isopropylphenol, 4-butylphenol, 2-cyclopentylphenol, 2,3-dimethylphenol, 2,3,6-trimethylphenol, 2,6-diisopropylphenol, 3,5-di-tert-butylphenol, 2,6-di-tert-butyl-4-methylphenol, 5-indanol, 5,6,7,8-tetrahydro-1-naphthol, naphthol, nonylphenol, 4-hydroxystyrene, 4-hydroxy-α-methylstyrene, 1,1′-bi(2-naphthol), catechol, resorcinol, hydroquinone, 2-methylresorcinol, 4-hexylresorcinol, 2,6-dihydroxynaphthalene, bis(4-hydroxyphenyl) methane, 2,2-bis(4-hydroxyphenyl)propane, 2,2-bis(4-hydroxy-3-methylphenyl)propane, 2,2′-biphenol, 4,4′-biphenol, phenylhydroquinone, 1,3,5-trihydroxybenzene, 2,4-di(4-hydroxyphenyl)-4-methyl-1-pentene, 2,4,6-tri(4-hydroxyphenyl)-2,6-dimethyl-3-hexene, 5-hydroxy-3-(4-hydroxyphenyl)-1,1,3-trimethyl-2,3-dihydroindene, 5-hydroxy-3-(4-hydroxyphenyl)-2,6-dimethyl-3-hexene, tri(4-hydroxyphenyl)methane and the like.

In the process of the first invention, OZ² in the carboxylic acid anhydride represented by the formula (3) indicates an organic group formed by elimination of active hydrogen from carboxylic acid.

As the carboxylic acid from which the organic group OZ² is derived, there can be mentioned, for example, branched or umbranched, aliphatic, alicyclic or aromatic carboxylic acids consisting of carbon atom, hydrogen atom and oxygen atom of carboxyl group, such as formic acid, acetic acid, propionic acid, butyric acid, isobutyric acid, acrylic acid, methacrylic acid, lauric acid, stearic acid, oleic acid, phenylacetic acid, cyclohexanecarboxylic acid, benzoic acid, paramethylbenzoic acid, 2-naphthalenecarboxylic acid, 2-norbornanecarboxylic acid, 2-norbornenecarboxylic acid, oxalic acid, malonic acid, succinic acid, maleic acid, fumaric acid, adipic acid, itaconic acid, butanetetracarboxylic acid, phthalic acid, isophthalic acid, terephthalic acid, trimellitic acid, pyromellitic acid, poly(acrylic acid), poly(methacrylic acid) and the like; halogen atom-containing, branched or umbranched, aliphatic, alicyclic or aromatic carboxylic acids, such as 4-chlorobutyric acid, 5-fluoro-2-hexanoic acid, pentafluorophenylacetic acid, 4-chlorobenzoic acid, 3-bromocyclohexanecarboxylic acid, 5-chloro-2-bicyclo[2.2.1]heptanecarboxylic acid, 6-iodo-1-naphthalenecarboxylic acid and the like; ether linkage-containing, branched or umbranched, aliphatic, alicyclic or aromatic carboxylic acids, such as methoxyacetic acid, 4-(4-methylphenoxy)butyric acid, 3-phenoxyphenylacetic acid, 2,2′-ethylenedioxy-diacetic acid, 3-benzyloxycyclohexanecarboxylic acid, 5,6-dimethoxy-2-bicyclo[2.2.1]heptanecarboxylic acid, 3-phenoxycinnamic acid, 5-methoxyisophthalic acid, 4,4′-ethylenedioxybenzoic acid and the like; ester linkage-containing, branched or umbranched, aliphatic, alicyclic or aromatic carboxylic acids, such as 4-acetoxybutyric acid, monoisopropyl succinate, monomethyl fumarate, monoethyl 1,3-cyclohexanedicarboxylate, monohexyl 2,6-norbomanedicarboxylate, 4-hydroxycarbonylbenzyl acrylate, cyclohexyl 5-methyl-1,3-benzenedicarboxylate, 1,2-di(4-hydroxycarbonylbenzoyloxy)ethane, poly(lactic acid), poly(ε-caprolactane) and the like; and amide linkage-containing, branched or umbranched, aliphatic, alicyclic or aromatic carboxylic acids, such as N-acetylalanine, 3-(N,N-dimethylcarbamoyl)propionic acid, N-methacryloylphenylglycine, N-(4-hydroxycyclohexyl)benzamide, 5-(N,N-diethylcarbamoyl)-1-naphthalenecarboxylic acid, N,N′-(4-hydroxyphenyl)terephthalamide and the like. These may have any other substituent as long as the process of the first invention is not impaired thereby.

Of these, preferred are branched or umbranched, aliphatic or aromatic carboxylic acids consisting of carbon atom, hydrogen atom and oxygen atom of carboxyl group, such as formic acid, acetic acid, propionic acid, butyric acid, isobutyric acid, acrylic acid, methacrylic acid, lauric acid, stearic acid, oleic acid, phenylacetic acid, benzoic acid, paramethylbenzoic acid, 2-naphthalenecarboxylic acid, oxalic acid, malonic acid, succinic acid, maleic acid, fumaric acid, adipic acid, itaconic acid, butanetetracarboxylic acid, phthalic acid, isophthalic acid, terephthalic acid, trimellitic acid, pyromellitic acid, poly(acrylic acid), poly(methacrylic acid) and the like.

More preferred are branched or umbranched, aliphatic carboxylic acids of 1 to 12 carbon atoms or aromatic carboxylic acids of 7 to 12 carbon atoms, all consisting of carbon atom, hydrogen atom and oxygen atom of carboxyl group, such as formic acid, acetic acid, propionic acid, butyric acid, isobutyric acid, acrylic acid, methacrylic acid, lauric acid, phenylacetic acid, benzoic acid, paramethylbenzoic acid, 2-naphthalenecarboxylic acid, oxalic acid, malonic acid, succinic acid, maleic acid, fumaric acid, adipic acid, itaconic acid, butanetetracarboxylic acid, phthalic acid, isophthalic acid, terephthalic acid, trimellitic acid, pyromellitic acid and the like.

The carboxylic acid ester represented by the formula (2) is more preferably a carboxylic acid ester of formula (2) wherein R¹ is a branched or umbranched alkyl group of 1 to 6 carbon atoms, a branched or umbranched alkenyl group of 2 to 4 carbon atoms, an aryl group of 6 to 10 carbon atoms, a branched or umbranched aliphatic hydrocarbon group containing 3 to 13 carbon atoms and having one or more carboxylic acid ester groups, or an aromatic hydrocarbon group containing 8 to 16 carbon atoms and having one or more carboxylic acid ester groups, and OZ¹ is an organic group derived from a branched or umbranched aliphatic alcohol of 1 to 20 carbon atoms consisting of carbon atom, hydrogen atom and oxygen atom of alcoholic hydroxyl group, or from a phenol of 6 to 27 carbon atoms consisting of carbon atom, hydrogen atom and oxygen atom of phenolic hydroxyl group.

The carboxylic acid anhydride represented by the formula (3) is more preferably a carboxylic acid anhydride of formula (3) wherein R¹ is a branched or umbranched alkyl group of 1 to 6 carbon atoms, an aryl group of 6 to 10 carbon atoms, or an aromatic hydrocarbon group containing 8 to 16 carbon atoms and having one or more carboxylic acid anhydride groups, and OZ² is an organic group derived from a branched or umbranched, aliphatic or aromatic carboxylic acid of 1 to 12 carbon atoms consisting of carbon atom, hydrogen atom and oxygen atom of carboxyl group.

The sulfonic acid ester represented by the formula (4) is more preferably a sulfonic acid ester of formula (4) wherein R¹ is a branched or umbranched alkyl group of 1 to 6 carbon atoms, or an aryl group of 6 to 10 carbon atoms, and OZ¹ is an organic group derived from a branched or umbranched aliphatic alcohol of 1 to 20 carbon atoms consisting of carbon atom, hydrogen atom and oxygen atom of alcoholic hydroxyl group, or from a phenol of 6 to 27 carbon atoms consisting of carbon atom, hydrogen atom and oxygen atom of phenolic hydroxyl group.

The carboxylic acid ester represented by the formula (2) or the sulfonic acid ester represented by the formula (4) is expressed in a form wherein one active hydrogen atom in an alcohol or phenol from which OZ¹ in formula (2) or formula (4) is derived, has been replaced by R¹CO— group or R¹SO₂— group. However, in some cases, the alcohol or phenol has a plurality of active hydrogen atoms. A compound wherein part or all of the active hydrogen atoms in the alcohol or phenol have been replaced by R¹CO— group or R¹SO₂— group, is also included in the carboxylic acid ester represented by the formula (2) or the sulfonic acid ester represented by the formula (4), in the process of the first invention.

The carboxylic acid anhydride represented by the formula (3) is expressed in a form wherein the active hydrogen atom of one carboxyl group in a carboxylic acid from which OZ² in formula (3) is derived, has been replaced by R¹CO— group. However, in some cases, the carboxylic acid has a plurality of carboxyl groups. A compound wherein the active hydrogen atom(s) in part or all of the carboxyl groups in carboxylic acid has (have) been replaced by R¹CO— group, is also included in the carboxylic acid anhydride represented by the formula (3), in the process of the first invention.

When the epoxy compound is contacted with the carbonic acid ester represented by the formula (5), either or both of an oxyalkylene derivative having a substructure represented by the formula (9) and an oxyalkylene derivative having a substructure represented by the formula (10) are obtained. The proportions of these derivatives obtained differ depending upon the combination of the kind of R² and the kind of OZ¹ in the carbonic acid ester represented by the formula (5).

That is, when R² in the carbonic acid ester represented by the formula (5) is an aliphatic hydrocarbon group of 1 to 35 carbon atoms and further when OZ¹ is an organic group derived from an alcohol, an oxyalkylene derivative having a substructure represented by the formula (9) and an oxyalkylene derivative having a substructure represented by the formula (10) are obtained in the same degree; when OZ¹ is an organic group derived from a phenol, an oxyalkylene derivative having a substructure represented by the formula (9) is obtained as a main product.

Meanwhile, when R² in the carbonic acid ester represented by the formula (5) is an aromatic hydrocarbon group of 6 to 35 carbon atoms and further when OZ¹ is an organic group derived from an alcohol, an oxyalkylene derivative having a substructure represented by the formula (10) is obtained as a main product; when OZ¹ is an organic group derived from a phenol, an oxyalkylene derivative having a substructure represented by the formula (9) and an oxyalkylene derivative having a substructure represented by the formula (10) are obtained in about the same degree.

When R² in the carbonic acid ester represented by the formula (5) is an aliphatic hydrocarbon group of 1 to 35 carbon atoms, such an aliphatic hydrocarbon group includes branched or umbranched alkyl groups of 1 to 35 carbon atoms, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, hentriacontyl, dotriacontyl, tritriacontyl, pentatriacontyl and the like; cycloalkyl groups of 3 to 35 carbon atoms, such as cyclopropyl, cyclobutyl, cyclopentyl, cyclohexyl, cycloheptyl, cyclooctyl, cyclononyl, cyclodecyl, cycloundecyl, cyclododecyl, cyclotridecyl, cyclotetradecyl, cyclopentadecyl, cyclohexadecyl, cycloheptadecyl, cyclooctadecyl, cyclononadecyl, cycloeicosyl, 2,3,4,5,6,7-hexahydroindenyl, 2-norbornyl, 5-norbornen-2-yl, adamantyl and the like; and branched or umbranched alkenyl groups of 2 to 35 carbon atoms, such as vinyl, isopropenyl, allyl, 1-butenyl, 2-butenyl, 3-butenyl, 1-pentenyl, 2-pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenyl and the like.

Of these, preferred are branched or umbranched alkyl groups of 1 to 35 carbon atoms, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, hentriacontyl, dotriacontyl, tritriacontyl, pentatriacontyl and the like.

More preferred are branched or umbranched alkyl groups of 1 to 6 carbon atoms, such as methyl, ethyl, propyl, butyl, pentyl, hexyl and the like.

When R² in the carbonic acid ester represented by the formula (5) is an aromatic hydrocarbon group of 6 to 35 carbon atoms, such an aromatic hydrocarbon group includes, for example, phenyl, tolyl, 2-ethylphenyl, 4-tert-butylphenyl, 4-nonylphenyl, 2-cyclohexylphenyl, 4-vinylphenyl, 4-isopropenylphenyl, 3-phenylphenyl, 1-naphthyl, 2-naphthyl, 5-methyl-1-naphthyl, 6-vinyl-2-naphthyl, anthracen-1-yl, phenanthren-1-yl, 1-(1-naphthyl)-2-naphthyl, 4-chlorophenyl, pentafluorophenyl, 2,6-dibromophenyl, 2,4-diiodophenyl, 5-fluoro-1-naphthyl and 6-bromo-2-naphthyl. These may have any other substituent as long as the process of the first invention is not impaired thereby.

Of these, preferred are aromatic hydrocarbon groups of 6.to 12 carbon atoms, such as phenyl, tolyl, 2-ethylphenyl, 4-tert-butylphenyl, 2-cyclohexylphenyl, 4-vinylphenyl, 4-isopropenylphenyl, 3-phenylphenyl, 1-naphthyl, 2-naphthyl, 5-methyl-1-naphthyl, 6-vinyl-2-naphthyl, 4-chlorophenyl, pentafluorophenyl, 2,6-dibromophenyl, 2,4-diiodophenyl, 5-fluoro-1-naphthyl, 6-bromo-2-naphthyl and the like.

More preferred are aromatic hydrocarbon groups of 6 to 9 carbon atoms, such as phenyl, tolyl, 2-ethylphenyl, 4-vinylphenyl, 4-isopropenylphenyl, 4-chlorophenyl, pentafluorophenyl, 2,6-dibromophenyl, 2,4-diiodophenyl and the like.

The carbonic acid ester represented by the formula (5) is more preferably a carbonic acid ester of the formula (5) wherein R² is a branched or umbranched alkyl group of 1 to 6 carbon atoms or an aromatic hydrocarbon group of 6 to 9 carbon atoms, and OZ¹ is an organic group derived from a branched or umbranched aliphatic alcohol of 1 to 20 carbon atoms consisting of carbon atom, hydrogen atom and oxygen atom of alcoholic hydroxyl group or from a phenol of 6 to 27 carbon atoms consisting of carbon atom, hydrogen atom and oxygen atom of phenolic hydroxyl group.

The carbonic acid ester represented by the formula (5) is expressed in a form wherein one active hydrogen atom in an alcohol or phenol from which OZ¹ in the formula (5) is derived, has been replaced by R²OCO— group. However, in some cases, the alcohol or phenol has a plurality of active hydrogen atoms. A compound obtained by replacing part or all of the active hydrogen atoms present in the alcohol or phenol by R²OCO— group, is also included in the carbonic acid ester represented by the formula (5), in the process of the first invention.

In the process of the first invention, the ester linkage-containing epoxy compound of various epoxy compounds mentioned above is classified as an epoxy compound or as a carboxylic acid ester represented by the formula (2) and, therefore, can function as two kinds of raw materials for reaction. When the ester linkage-containing epoxy compound is reacted with a compound represented by the formula (2), (3), (4) or (5), whether the epoxy group in the epoxy compound reacts with the ester moiety of the epoxy compound or with the compound represented by the formula (2), (3), (4) or (5), differs depending upon the reactivity of the compound used. When two or more kinds of the compounds represented by the formulas (2), (3), (4) and (5) are used in combination or when a compound represented by the formula (2), (3), (4) or (5) is classified as two or more kinds of the compounds represented by the formulas (2), (3), (4) and (5), the substructure(s) of the oxyalkylene derivative(s) formed varies (vary) depending upon the reactivities of the individual compounds used.

In the process of the first invention, an epoxy compound is contacted with a carboxylic acid ester represented by the formula (2), a carboxylic acid anhydride represented by the formula (3), a sulfonic acid ester represented by the formula (4), or a carbonic acid ester represented by the formula (5), in the presence of a phosphine compound represented by the formula (1).

In the process of the first invention, it is preferred that the reaction system is made homogeneous by the use of a solvent; however, the system may be in heterogeneous plural layers or in plural layers containing a solid and a liquid.

There is no particular restriction as to the procedure of the reaction. When there are used a phosphine compound represented by the formula (1), an epoxy compound, a compound represented by the formula (2), (3), (4) or (5), and a solvent, the reaction may be batchwise, semi-batchwise or continuous as long as the solvent can be allowed to make efficient contact. An autoclave may be used as necessary. Ordinarily, various processes such as the followings are used. A process which comprises adding an epoxy compound in one portion to a mixture of a phosphine compound represented by the formula (1) and a compound represented by the formula (2), (3), (4) or (5) and, when a solvent is used, to a mixture containing even the solvent; a process which comprises adding the epoxy compound intermittently or continuously; and a process which comprises adding a phosphine compound represented by the formula (1) to a mixture of an epoxy compound and a compound represented by the formula (2), (3), (4) or (5) and, when a solvent is used, to a mixture containing even the solvent.

As to the amount of the carboxylic acid ester represented by the formula (2), the carboxylic acid anhydride represented by the formula (3), the sulfonic acid ester represented by the formula (4) or the carbonic acid ester represented by the formula (5) used relative to the epoxy compound, the amount of R¹CO— group, R¹SO₂— group or R²OCO— group in the above compounds is generally 0.5 to 1.5 mole, preferably 0.7 to 1.3 mole relative to 1 mole of epoxy group in the epoxy compound.

As to the use amount of the phosphine compound represented by the formula (1), there is no particular restriction in any case. However, the amount is generally 0.5 mole or less, preferably 1×10⁻⁵ to 0.1 mole, more preferably 1×10⁻⁴ to 0.05 mole relative to 1 mole of epoxy group in the epoxy compound.

The reaction temperature varies in all cases depending upon the kinds of the raw materials and phosphine compound of the formula (1) used; however, the temperature is generally 200° C. or less, preferably 10 to 180° C., more preferably 30 to 150° C. The pressure during the reaction varies in all cases depending upon the kinds of raw materials used and the reaction temperature used; however, the pressure is generally 3.0 MPa (absolute pressure, the same applies hereinafter) or less, preferably 0.01 to 1.5 MPa, more preferably 0.1 to 1.0 MPa. The reaction time is generally within 48 hours, preferably 0.01 to 24 hours, more preferably 0.02 to 10 hours. The reaction may be carried out, as necessary, in the presence of an inert gas, such as nitrogen, argon or the like.

In the process of the first invention, a reaction substrate, i.e. the carboxylic acid ester, the carboxylic acid anhydride, the sulfonic acid ester or the carbonic acid ester may be used a solvent. However, other solvent may be used if necessary. As such a solvent, there can be mentioned aliphatic or alicyclic hydrocarbons, such as n-pentane, n-hexane, cyclohexane and the like; ethers ,such as dimethyl ether, diethyl ether, diisopropyl ether, dibutyl ether, tetrahydrofuran, 1,4-dioxane, ethylene glycol dimethyl ether, diethylene glycol dimethyl ether, anisole, o-dimethoxybenzene, ethyl phenyl ether, butyl phenyl ether, o-diethoxybenzene and the like; aromatic hydrocarbons, such as benzene, toluene, xylene, ethylbenzene, cumene, mesitylene, tetralin, butylbenzene, p-cymene, diethylbenzene, diisopropylbenzene, triethylbenzene, cyclohexylbenzene, dipentylbenzene, dodecylbenzene and the like; halogenated hydrocarbons, such as chlorobenzene, o-dichlorobenzene, m-dichlorobenzene, 1,2,4-trichlorobenzene, bromobenzene, o-dibromobenzene, bromochlorobenzene, o-chlorotoluene, p-chlorotoluene, p-chloroethylbenzene, 1-chloronaphthalene and the like; and aprotic polar solvents, such as dimethyl sulfoxide, N,N-dimethylformamide, hexamethylphosphoramide, N-methyl-2-pyrrolidinone, N,N′-dimethylimidazolidinone and the like. Any other solvent may be used as long as the object of the process of the first invention is not impaired thereby. These solvents may be used singly or in combination of two or more kinds. The amount of the solvent used is generally 1,000 times or less the weight of the epoxy compound which is a reaction substrate, preferably 0 to 500 times, more preferably 0 to 100 times.

In isolating an intended oxyalkylene derivative from the reaction mixture, any of the isolation methods used ordinarily can be used. However, the method used is not definite in any case depending upon the kinds of the raw materials used, the kind of the oxyalkylene derivative intended, the kind and amount of the solvent used, etc. An intended oxyalkylene derivative can be obtained ordinarily by subjecting the reaction mixture or the solvent-removed reaction mixture when a solvent was used, to a separation method such as distillation, recrystallization, crystallization, extraction, column chromatography or the like.

In one preferred embodiment of the process of the first invention, the reaction is conducted in a system substantially free from an active hydrogen-containing compound, from a standpoint that the reaction of the present invention is not prevented.

By thus contacting an epoxy compound with a carboxylic acid ester represented by the following formula (2), a carboxylic acid anhydride represented by the following formula (3), a sulfonic acid ester represented by the following formula (4) or a carbonic acid ester represented by the following formula (5), in the presence of a phosphine compound represented by the formula (1):

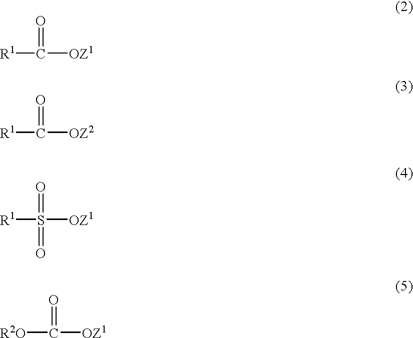

[in the formulas (2) to (5), R¹, R², OZ¹ and OZ² have the same definitions as given above], there can be produced, correspondingly to each of the compounds having formulas (2) to (5), an oxyalkylene derivative having the substructure represented by the formula (6), the substructure represented by the formula (7), the substructure represented by the formula (8), or the substructure represented by the formula (9) and/or the substructure represented by the formula (10), at a very high catalytic activity at a high yield:

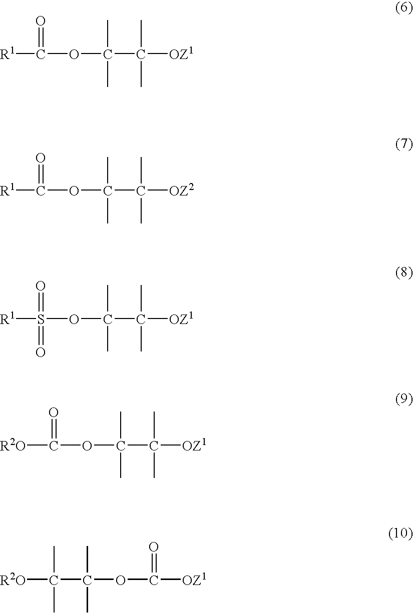

[in the formulas (6) to (10), R¹, R², OZ¹ and OZ² have the same definitions as in the formulas (2) to (5)].

Next, the components (A), (B), (C) and (D) constituting the second invention are described in detail.

First, description is made on the curing accelerator (C) which has the most important meaning in the second invention.

In the epoxy resin composition of the second invention, an important constituent element is (C) a curing accelerator.

That is, a phosphine compound represented by the following formula (1), preferably a phosphine compound represented by the following general formula (I) is contained in an amount of 30 to 100% by weight in the total curing accelerator.

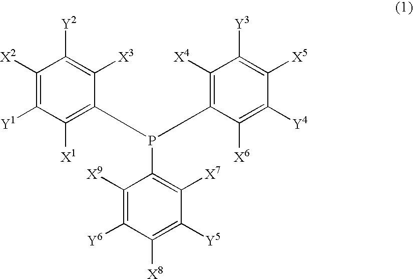

[in the formula (1), X¹ to X⁹ and Y¹ to Y⁶ are each independently a hydrogen atom, an aliphatic or alicyclic hydrocarbon group of 1 to 10 carbon atoms, an aromatic hydrocarbon group of 6 to 10 carbon atoms, an alkoxy group of 1 to 10 carbon atoms, or an aryloxy group of 6 to 10 carbon atoms, with a proviso that at least three of X¹ to X⁹ are an alkoxy group of 1 to 10 carbon atoms].

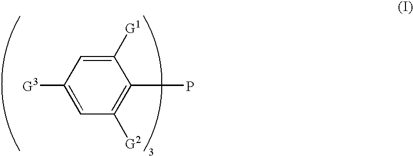

(in the above formula, G¹ to G³ are each independently a hydrogen atom and an alkoxy group of 1 to 6 carbon atoms, with a proviso that G¹ and G² are not a hydrogen atom simultaneously).

As specific examples of a more preferred phosphine compound, there can be mentioned tris(2-methoxyphenyl)phosphine, tris(2,4-dimethoxyphenyl)phosphine, tris(2,6-dimethoxyphenyl)phosphine and tris(2,4,6-trimethoxyphenyl)phosphine. The amount of the phosphine compound used is 30 to 100% by weight in the total curing accelerator.

In the epoxy resin composition of the second invention, there may be used other well-known curing accelerators used generally, as long as the feature of the present invention is not lost. They are, for example, imidazoles, such as 2-methylimidazole and the like; phosphines, such as triphenylphosphine, tributylphosphine, tricyclohexylphenylphosphine, tris(4-methoxyphenyl)phosphine, tris(2-methylphenyl)phosphine, tris(2,4-dimethylphenyl)phosphine, tris(2,4,6-trimethylphenyl)phosphine, tris(cyanoethyl)phosphine, tris(hydroxypropyl)phosphine and the like; tertiary amines, such as triethylamine and the like; diazabicyclo compounds, such as 1,8-diazabicyclo(5,4,0)undecene-7 and the like; and pyridines, such as 4-N,N-dimethylaminopyridine and the like.

As the component (A), i.e. the epoxy compound having two or more functions or the epoxy resin having two or more functions, there can be used any compound or resin having two or more epoxy groups in the molecule.

As specific examples, there can be mentioned the followings.

That is, epoxy group-containing compounds or resins obtained by, for example, oxidation of olefin, conversion of hydroxyl group into glycidyl ether, conversion of primary or secondary amine into glycidyl amine, or conversion of carboxylic acid into glycidyl ester.

As the raw material for obtaining such an epoxy group-containing compound or resin, there can be mentioned, for example, dihydroxybenzenes, such as catechol, resorcinol, hydroquinone and the like; bisphenols, such as 2,6-dihydroxynaphthalene, 2,7-dihydroxynaphthalene, 1,6-dihydroxynaphthalene, 1,7-dihydroxynaphthalene, 2,2-bis(4-hydroxyphenyl)propane (bisphenol A), 2-(3-hydroxyphenyl)-2-(4′-hydroxyphenyl)propane, bis(4-hydroxyphenyl)methane (bisphenol F), bis(4-hydroxyphenyl)sulfone (bisphenol S), bis(4-hydroxyphenyl) sulfide, bis(4-hydroxyphenyl)methylcyclohexane, bis(4-hydroxyphenyl)methylbenzene, 4,4′-dihydroxybiphenyl, 4,4′-dihydroxy-2,2′,6,6′-tetramethylbiphenyl, 4,4′-dihydroxydiphenyl ether, 6,6′-dihydroxy-3,3,3′,3′-tetramethyl-1,1-spirobiindane, 1,3,3-triemthyl-1-(4-hydroxymethyl)-1-indan-6-ol and the like; oligophenols, such as tetraphenylolethane, naphthol-cresol resole condensate and the like; phenol resins, such as phenol novolac represented by the following general formula (XI) and residue obtained by removing a bisphenol from the novolac (the residue is tri- or higher phenols and is hereinafter abbreviated as VR):

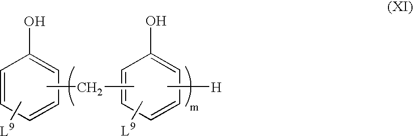

[in the formula (XI), L⁹s are a umbranched, branched or cyclic alkyl group of 1 to 6 carbon atoms, an aryl group or an alkoxy group; m which is a number of repeating unit, is 1 to 50 with the average being 1 to 20], phenol aralkyl represented by the following general formula (XII):

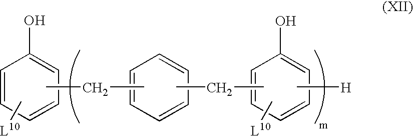

[in the formula (XII), L¹⁰s are a umbranched, branched or cyclic alkyl group of 1 to 6 carbon atoms, an aryl group or an alkoxy group; m which is a number of repeating unit, is 1 to 50 with the average being 1 to 20], naphthol aralkyl represented by the following general formula (XIII):

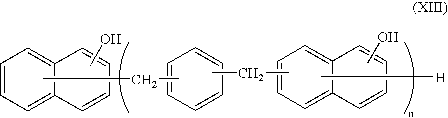

[in the formula (XIII), n which is a number of repeating unit, is 1 to 20 with the average being 1 to 5], phenol-dicyclopentadiene copolymer resin (DPR resin) represented by the following general formula (XIV):

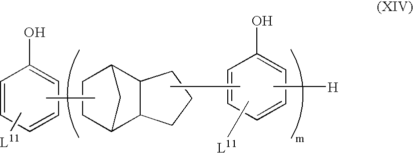

[in the formula (XIV), L¹¹s are a umbranched, branched or cyclic alkyl group of 1 to 6 carbon atoms, an aryl group or an alkoxy group; m which is a number of repeating unit, is 1 to 50 with the average being 1 to 20], and the like; aliphatic or aromatic amines, such as ethylenediamine, propylenediamine, hexamethylenediamine, aniline, 4,4′-diaminophenylmethane (MDA), 4,4′-diaminodiphenyl ether, 4,4′-diaminodiphenylsulfone, 2,2-bis(4,4′-diaminophenyl)propane, m-xylylenediamine, p-xylylenediamine, 1,2-diaminocyclohexane, aniline aralkyl resin (trade name: Anilix, a product of Mitsui Chemicals, Inc.) represented by the following general formula (X):

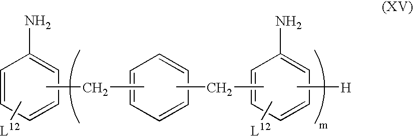

[in the above formula, R₁₁ is a umbranched, branched or cyclic alkyl group of 1 to 6 carbon atoms, an aryl group or an alkoxy group; m which is a number of repeating unit, is 1 to 50 with the average being 1 to 20] and the like; aminophenols, such as m-aminophenol, p-aminophenol, 2-(4-aminophenyl)-2-(4′-hydroxyphenyl)propane, 4-aminophenyl-4-hydroxyphenylmethane and the like; carboxylic acids, such as phthalic acid, isophthalic acid, terephthalic acid, tetrahydrophthalic acid, hexahydrophthalic acid, dimer acid, 1,3-dicarboxycyclohexane and the like; and hydroxycarboxylic acids, such as salicylic acid, 4-hydroxybenzoic acid and the like.

Conversion of such a compound having active hydrogen atom into a glycidyl compound can be conducted by a well-known method and, most commonly, by reacting the former compound with epichlorohydrin in the presence of a hydrogen halide acceptor. Incidentally, it is known that in producing a glycidyl ester, there is preferred a method of reacting a methyl carboxylate with glycidol using a metal catalyst, particularly a thallium compound such as TINO₃, TI(OCOCF₃)₃ or the like.

Of these, preferred as an encapsulating material for semiconductor integrated circuit which is a main object of the present invention, are glycidyl ethers derived from phenolic compounds or phenolic resins. They are specifically epoxy compounds derived from dihydroxynaphthalenes, epoxy resins derived from biphenols, epoxy resins obtained from phenol novolac resins represented by the general formula (X), epoxy resins obtained form phenol aralkyl resins represented by the general formula (XI), epoxy resins obtained from phenol-dicyclopentadiene resins represented by the general formula (XIII), etc.

The curing agent component (B), i.e. the ester group-containing compound or the ester group-containing resin formed by acylating the hydroxyl group of a phenol compound having two or more functions or a phenol resin having two or more functions, has an esterification percentage of 10 to 100 mole %, preferably 50 to 100 mole %, more preferably 75 to 100 mole %, further preferably 90 to 100 mole %, most preferably 91.0 to 100 mole %. As the esterification percentage is larger, the cured material obtained has a smaller moisture absorption. The esterification percentage can be determined appropriately in view of the balance of other properties.

Incidentally, the esterification percentage is determined from the hydroxyl equivalents of raw material phenol compound or phenol resin before and after acylation of hydroxyl group, using the following calculation formula. Here, the hydroxyl equivalent (unit: g/eq) is measured according to the procedure of JIS K 0070.

X={(B−A)/(B+M−1)}×100

[in the above formula, X is an esterification percentage; A and B are the hydroxyl equivalents (g/eq) of raw material phenol compound or phenol resin before and after acylation; and M is a molecular weight of acyl group].

Specifically, there can be mentioned, for example, esterified products of phenol compounds or phenol resins which were mentioned previously as a raw material for epoxy resin. They are preferably ester group-containing resins derived from a novolac type resin represented by the following general formula (VIII):

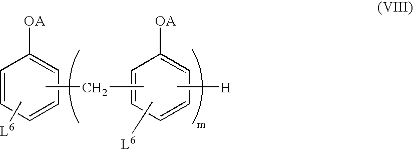

[in the formula (VIII), L⁶s are hydrogen atom, a umbranched, branched or cyclic alkyl group of 1 to 6 carbon atoms, an aryl group or an alkoxy group; As are a hydrogen atom or an aromatic or aliphatic acyl group of 2 to 10 carbon atoms, with a proviso that the molar ratio of hydrogen atom/acyl group is in a range of 90/10 to 0/100; and m which is a number of repeating unit, is 1 to 50 with the average being 1 to 20],

ester group-containing resins derived from a phenol aralkyl resin represented by the following general formula (IX):

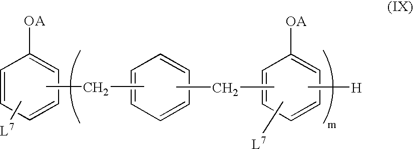

[in the formula (IX), L⁷s are hydrogen atom, a umbranched, branched or cyclic alkyl group of 1 to 6 carbon atoms, an aryl group or an alkoxy group; As are a hydrogen atom or an aromatic or aliphatic acyl group of 2 to 10 carbon atoms, with a proviso that the molar ratio of hydrogen atom/acyl group is in a range of 10/90 to 0/100; and m which is a number of repeating unit, is 1 to 50 with the average being 1 to 20], and

ester group-containing resins derived from a phenol-dicyclopentadiene type resin represented by the following general formula (X):

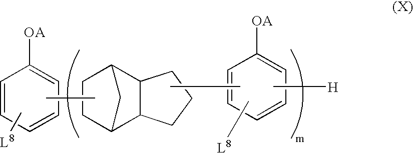

[in the formula (X), L⁸s are hydrogen atom, a umbranched, branched or cyclic alkyl group of 1 to 6 carbon atoms, an aryl group or an alkoxy group; As are hydrogen atom or an aromatic or aliphatic acyl group of 2 to 10 carbon atoms, with a proviso that the molar ratio of hydrogen atom/acyl group is in a range of 10/90 to 0/100; and m which is a number of repeating unit, is 1 to 50 with the average being 1 to 20].

Esterification of these phenol resins is conducted by a well-known method. It is conducted specifically as follows. That is, as the esterifying agent used in esterification of the above-mentioned hydroxyl group, any of organic acid anhydrides, organic acid halides and organic carboxylic acids can be used. Selection may be made appropriately depending upon the feature of the esterifying agent based on the carbon number of the ester to be derived. As specific examples of the esterifying agent, there can be mentioned acetic anhydride, acetyl chloride, acetyl bromide, acetic acid, propionic anhydride, propionic chloride, propionic bromide, propionic acid, butyric anhydride, butyric chloride, butyric acid, valeric anhydride, valeric chloride, valeric bromide, valeric acid, pivalic chloride, pivalic acid, phenylacetic acid, phenylacetic chloride, 2-phenylpropionic acid, 3-phenylpropionic acid, o-tolylacetic acid, m-tolylacetic acid, p-tolylacetic acid, cumic acid, benzoic anhydride, benzoic chloride, benzoic bromide, o-methylbenzoic chloride, m-methylbenzoic chloride, p-methylbenzoic chloride, o-methylbenzoic acid, m-methylbenzoic acid, p-methylbenzoic acid, 2,3-dimethylbenzoic acid, 2,4-dimethylbenzoic acid, 2,5-dimethylbenzoic acid, 2,6-dimethylbenzoic acid, 3,4-dimethylbenzoic acid, 3,5-dimethylbenzoic acid and the like. Of these, preferred are acetic anhydride, acetyl chloride, benzoic anhydride and benzoic chloride. These esterifying agents can be used singly or in combination of two or more kinds.

The amount of the esterifying agent used may be 10 mole % or more relative to hydroxyl group and there is no particular restriction as to the upper limit. When it is desired to conduct esterification sufficiently by using the esterifying agent in excess, the excessive amount may be removed after the completion of the esterification reaction; however, the practical amount of the esterifying agent used is 10 moles or less, preferably 5 moles or less, more preferably 3 moles or less relative to 1 mole of hydroxyl group, from the standpoints of volume efficiency of reaction, cost, etc.

The specific method used for esterification differs depending upon the kind of the esterifying agent used. Description is made for individual esterifying agents. When an organic carboxylic anhydride is used, an ordinarily used method is employed. That is, an appropriate amount of an organic carboxylic anhydride as an esterifying agent is reacted with hydroxyl group; an organic carboxylic acid formed as a by-product and a excess amount of the organic carboxylic anhydride are removed by an appropriate method such as atmospheric distillation, vacuum distillation, water washing, washing with weakly basic aqueous solution (e.g. carbonate-containing water), or the like, or by a combination thereof; thereby, an intended ester compound is obtained. When partial esterification is conducted, an organic carboxylic anhydride is used in an appropriate amount, that is, in an amount of 10 mole % or more relative to hydroxyl group because, in the resin composition of the present invention, an esterified product obtained by esterifying epoxy group by 10 mole % or more is used; when complete esterification is conducted, an organic carboxylic anhydride is used in an amount of equal mole or more relative to hydroxyl group and, when functioning also as a solvent (in this case, there is no particular restriction as to the upper limit), in an amount of 10 moles or less per mole of hydroxyl group in view of the economic efficiency and the volume efficiency of reaction. Incidentally, the above amounts apply also in the later-described reaction using an organic carboxylic acid.

In general, an esterification reaction is often conducted in the presence of an inactive organic base in a reaction of pyridine, piperidine, triethylamine or the like. Meanwhile, when the epoxy resin composition of the present second invention is used in electric and electronic fields (e.g. an encapsulating material for semiconductor integrated circuit), the remaining of such a nitrogen-containing organic base must be avoided. Therefore, it is desired that a step for water washing is employed finally. However, since a reaction proceeds sufficiently without using such an organic base, it is most desired not to use the organic base.

The reaction temperature is 60 to 200° C., desirably 80 to 180° C., particularly desirably 100 to 160° C. The reaction time differs greatly depending upon the kinds of the reactants and the reaction temperature, but is 1 to 25 hours. Practically, it is desired to determine the end point of the reaction while tracing, for example, the disappearances of esterifying agent used and hydroxyl group by high performance liquid chromatography, gas chromatography or the like.

In the reaction, a solvent may be used or not. The reaction may be conducted in a solvent-free state when the hydroxyl group-containing substance as a raw material melts sufficiently at the reaction temperature and further the esterifying agent is a liquid, or when the substance melts or dissolved in the resin at the reaction temperature and poses no problem in the reaction.

When a solvent is required, any solvent inert in the reaction can be used. Examples thereof are aromatic hydrocarbons, such as benzene, toluene, xylene, chlorobenzene, o-dichlorobenzene, diphenyl ether and the like; aprotic polar solvents, such as N,N-dimethylformamide, N,N-dimethylacetamide, N-methyl-2-pyrrolidone, N,N-dimethyl-2-imidazolidinone, dimethyl sulfoxide, sulfolane and the like; ethers, such as tetrahydrofuran, dioxane, ethylene glycol dimethyl ether, diethylene glycol dimethyl ether and the like; and ketones, such as acetone, methyl ethyl ketone, methyl isobutyl ketone and the like. These solvents can be used singly or in any combination thereof.

The reaction may be conducted at atmospheric pressure, under pressure (in autoclave) or under reduced pressure. The atmosphere in the reaction system may be any of air and an inert gas, such as nitrogen, argon, helium and the like, with a nitrogen atmosphere being preferred.

Next, description is made on the reaction when an organic carboxylic halide is used as the esterifying agent. In this case as well, a method ordinarily used can be employed. That is, an appropriate amount of an organic carboxylic halide as an esterifying agent is reacted with hydroxyl group. In this case, for removal of a hydrogen halide by-produced, there are considered a method of allowing a base inert to the reaction, e.g. pyridine, piperazine or triethylamine to be present in the reaction system in a necessary amount and capture the hydrogen halide in the reaction system; and a method of discharging the hydrogen halide in a gaseous state out of the reaction system as soon as it has been formed and capturing the discharged hydrogen halide using a water or alkali trap placed outside the reaction system. However, for the reason mentioned above, it is preferred to discharge the halogen halide gas out of the reaction system as soon as it has been formed, in order to avoid incorporation of nitrogen-containing compound and ionic compound. In this case as well, it is more preferred to conduct the reaction in a stream of a gas inter to the reaction.

The organic carboxylic halide is used in an appropriate amount, preferably 10 mole % or more relative to hydroxyl group when partial esterification is conducted and, when complete esterification is conducted, in an equimolar amount or in a slight excess relative to hydroxyl group. Use of an organic carboxylic anhydride in a large excess is not particularly restricted; however, in view of economic efficiency, volume efficiency of reaction, and complicated treatment step after reaction, the amount is 10 moles or less, preferably 5 moles or less, more preferably 3 moles or less per mole of hydroxyl group. The reaction temperature, the use of solvent in reaction and the procedure of reaction may be the same as in the above-mentioned case of organic carboxylic anhydride.

When an organic carboxylic acid is used as the esterifying agent, the esterification may be conducted in about the same manner as in the case of organic carboxylic anhydride. However, an acid catalyst is required in the reaction. Examples thereof are mineral acids, such as hydrochloric acid, sulfuric acid, phosphoric acid, polyphosphoric acid and the like; organic sulfonic acids, such as p-toluenesulfonic acid, methanesulfonic acid, ethanesulfonic acid, dimethylsuccinylsulfonic acid, diethylsuccinylsulfonic acid and the like; superacids represented by trifluoromethanesulfonic acid; acidic ion exchange resins represented by alkanesulfonic acid type; and superacid type ion exchange resins represented by perfluoroalkanesulfonic acid type.

The use amount thereof is 0.00001 to 5% by weight, preferably 0.0001 to 1% by weight, more preferably 0.001 to 0.1% by weight relative to the weights of the raw materials in the case of superacid; 1 to 100% by weight, preferably 10 to 50% by weight in the case of ion exchange resin; and 0.01 to 10% by weight, preferably 0.1 to 5% by weight in other cases. When the amount is smaller than the above ranges, the reaction rate is small and the reaction is not complete in a practical reaction time. When the amount is larger than the above ranges, the side reaction is not negligible, or complications of steps for catalyst removal, etc. incur an increase in cost.

In the above, description has been made on the reactions using three kinds of esterifying agents. In each case, when it is necessary to obtain an esterified product of higher purification degree, a water-washing step is adopted after the completion of the reaction. In this case, washing is conducted using a solvent which can be washed by water, such as toluene, xylene, methyl isobutyl ketone, methyl ethyl ketone, ethyl acetate or the like, until neither acidic components nor ionic impurities are found in the washings.

As to the proportions of the epoxy resin and the curing agent, the ester group or the total of the ester group and hydroxyl group, that is, the groups active to epoxy group are 0.5 to 1.5 mole equivalent, preferably 0.7 to 1.3 mole equivalent relative to 1 mole equivalent of epoxy group. However, it is more preferred that the epoxy resin and the curing agent are used in such a molar ratio that the cured material obtained can have the most appropriate properties.

In the epoxy resin composition of the second invention, the use amount of the phosphine compound which is a curing accelerator, is 0.1 to 25% by weight (0.1 to 25 g/100 g), preferably 0.5 to 15% by weight, more preferably 0.5 to 8% by weight relative to the resin components (the total of the epoxy resin and the curing agent).

In the epoxy resin composition of the present invention, (D) an organic and/or inorganic filler and other additives may be used as necessary. When the composition is used particularly as an encapsulating material for semiconductor integrated circuit, it is desired to use an organic and/or inorganic filler for improved mechanical properties as well as for total cost reduction, a coloring agent (e.g. carbon black) for prevention of malfunctioning caused by light, a release agent, a coupling agent, a flame retardant, etc.

The amount of the organic and/or inorganic filler used is 100 to 1,900 parts by weight, preferably 250 parts by weight or more, more preferably 550 parts by weight or more relative to 100 parts by weight of the total of the epoxy resin (A) and the curing agent (B).

As the organic and/or inorganic filler usable herein, there can be mentioned, for example, powders of silica, alumina, silicon nitride, silicon carbide, talc, calcium silicate, mica, clay, titanium white, etc.; and fibers such as glass fiber, carbon fiber, aramid fiber and the like. Of these, preferred for use in encapsulating material is crystalline silica and/or fused silica, and their shape is desired to be a sphere or a mixture of sphere and amorphous form in view of the fluidity of the resulting resin composition during molding.

It is preferred to further add various additives to the present epoxy resin composition in view of the mechanical strengths and heat resistance. For example, it is desired to use a coupling agent for improvement in adhesivity between resin and inorganic filler. As such a coupling agent, there can be mentioned a silane type, a titanate type, an aluminate type, a zircoaluminate type, etc. Of these, preferred is a silane coupling agent and most preferred is a silane coupling agent having functional group capable of reacting with epoxy group.

As such a coupling agent, there can be mentioned vinyltrimethoxysilane, vinyltriethoxysilane, N-(2-aminomethyl)-3-aminopropylmethyidimethoxysilane, N-(2-aminoethyl)-3-aminopropyltrimethoxysilane, 3-aminopropyltriethoxysilane, 3-anilinopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-methacryloxypropyltrimethoxysilane, 3-mercaptopropyltrimethoxysilane, etc. These can be used singly or in combination of two or more kinds. Desirably, these coupling agents are beforehand adsorbed or fixed by a reaction, on the surface of an inorganic filler.

The epoxy resin composition of the second invention may be produced by any method. For example, a curing accelerator (C) is melt-kneaded sufficiently in a curing agent and the resulting mixture is mixed with an epoxy resin; or, all of the above components are kneaded simultaneously; or, when sufficient uniformity is aimed, all the components may be dry-blended in a powdery state.

The epoxy resin cure material of the second invention is a cured material obtained by thermosetting the epoxy resin composition of the second invention.

The semiconductor device of the second invention is obtained by encapsulating a semiconductor integrated circuit using the epoxy resin composition of the second invention. The method for producing a semiconductor device is most generally low-pressure transfer molding. However, there can also be used other methods such as injection molding, compression molding, cast molding and the like. A special method such as using a solvent is also usable.

### EXAMPLES

Next, the present invention is described in more detail by Examples.

However, it should be understood that these Examples are not restrictive and are only for explanation.

### Example 101

In a 100-ml eggplant-shape flask were placed 0.442 g (1.00 mmol) of tris(2,6-dimethoxyphenyl)phosphine (abbreviated as “2,6-DMPP”) and 14.3 g (105 mmol) of phenyl acetate [a carboxylic acid ester of the formula (2) wherein R¹ is a methyl group and OZ¹ is an organic group derived from phenol]. The mixture was heated to 90° C. Thereto was dropwise added 15.0 g (100 mmol) of phenyl glycidyl ether (abbreviated as PGE) in 10 minutes. After the completion of the dropwise addition, the resulting mixture was stirred at the same temperature for 5 hours and then returned to room temperature in about 10 minutes. Part of the reaction mixture was collected and subjected to a quantitative analysis by gas chromatography using 1,3,5-trichlorobenzene as an internal standard. The PGE as a raw material was consumed almost completely, the analytical yield of intended 1,3-diphenoxy-2-propyl acetate was 95% (based on PGE), and the reaction proceeded almost quantitatively. The reaction mixture was directly subjected to column chromatography to obtain 25.8 g of 1,3-diphenoxy-2-propyl acetate as a colorless liquid. The isolation yield was 90%. The analytical data of the compound was identical with those of the reference standard. The catalytic activity (the moles of intended compound formed per mole of catalyst per unit time, the same applies hereinafter) of 2,6-DMPP was 20 mol/mol-h. Surprisingly, this catalytic activity was, respectively, about 14.5 times, 5.8 times, 4.8 times and 33.3 times those of N-methylimidazole, tetrabutylammonium chloride, potassium tert-butoxide and triphenylphosphine in the later-described Comparative Examples 102, 103, 104 or 105.

### Example 102

A reaction was conducted in the same manner as in Example 101 except that in Example 101, 2,6-DMPP was replaced by equal moles of tris(2,4,6-trimethoxyphenyl)phosphine (abbreviated as “TMPP”). As in Example 101, PGE as a raw material was consumed almost completely, the analytical yield of 1,3-diphenoxy-2-propyl acetate was 97%, and the isolation yield was 91%. The catalytic activity was very high at 20 mol/mol•h.

### Comparative Example 101

A reaction was conducted in the same manner as in Example 101 except that in Example 101, no 2,6-DMPP was used. The reaction proceeded hardly, and the analytical yield of 1,3-diphenoxy-2-propyl acetate was 2%.

### Comparative Example 102

A reaction was conducted in the same manner as in Example 101 except that in Example 101, 2,6-DMPP was replaced by 0.821 g (10.0 mmol) of N-methylimidazole (abbreviated as “NMI”). The analytical yield of 1,3-diphenoxy-2-propyl acetate was 66%, and the isolation yield was 61%. The catalytic activity was only 1.3 mol/mol•h.

### Comparative Example 103

A reaction was conducted in the same manner as in Example 101 except that in Example 101, 2,6-DMPP was replaced by 0.695 g (2.50 mmol) of tetrabutylammonium chloride (abbreviated as “TBAC”). The analytical yield of 1,3-diphenoxy-2-propyl acetate was 42%, and the isolation yield was 35%. The catalytic activity was only 3.4 mol/mol•h.

### Comparative Example 104

A reaction was conducted in the same manner as in Example 101 except that in Example 101, 2,6-DMPP was replaced by 0.23 g (2.50 mmol) of potassium tert-butoxide (abbreviated as “t-BuOK”). The analytical yield of 1,3-diphenoxy-2-propyl acetate was 48%, and the isolation yield was 37%. The catalytic activity was only 3.9 mol/mol•h.

### Comparative Example 105

A reaction was conducted in the same manner as in Example 101 except that in Example 101, 2,6-DMPP was replaced by equal moles of triphenylphosphine (abbreviated as “TPP”). The analytical yield of 1,3-diphenoxy-2-propyl acetate was 3%. The catalytic activity was only 0.6 mol/mol•h.

The results of Examples 101 and 102 and Comparative Examples 101 to 105 are shown in Table 1.

TABLE 1

| | | Catalyst | | |
|---|---|---|---|---|
| | | amount | Analytical | Catalytic |
| | | (molar ratio) | yield | activity |
| | Catalyst* | (catalyst/PGE) | (%) | (mol/mol · h) |
| Ex. 101 | 2,6-DMPP | 1.0 × 10⁻² | 95 | 20 |
| Ex. 102 | TMPP | 1.0 × 10⁻² | 97 | 20 |
| Comp. Ex. 101 | Not used | — | 2 | — |
| Comp. Ex. 102 | NMI | 10.0 × 10⁻² | 66 | 1.3 |
| Comp. Ex. 103 | TBAC | 2.5 × 10⁻² | 42 | 3.4 |
| Comp. Ex. 104 | t-BuOK | 2.5 × 10⁻² | 48 | 3.9 |
| Comp. Ex. 105 | TPP | 1.0 × 10⁻² | 3 | 0.6 |

*2,6-DMPP: tris(2,6-dimethoxyphenyl)phosphine
TMPP: tris(2,4,6-trimethoxyphenyl)phosphine
NMI: N-methylimidazole
TBAC: tetrabutylammonium chloride
t-BuOK: potassium t-butoxide
TPP: triphenylphosphine

### Example 103

A reaction was conducted in the same manner as in Example 101 except that in Example 101, 2,6-DMPP was replaced by equal moles of tris(2,4-dimethoxyphenyl)phosphine. The analytical yield of intended 1,3-diphenoxy-2-propyl acetate was as high as 95% and the isolation yield was 89%.

### Example 104

A reaction was conducted in the same manner as in Example 101 except that in Example 101, 2,6-DMPP was replaced by equal moles of tris(2,6-di-n-octyloxyphenyl)phosphine. The analytical yield of intended 1,3-diphenoxy-2-propyl acetate was as 91% and the isolation yield was 85%.

### Example 105

A reaction was conducted in the same manner as in Example 101 except that in Example 101, 2,6-DMPP was replaced by equal moles of tris(2,4,6-trimethoxy-3,5-dimethylphenyl)phosphine. The analytical yield of intended 1,3-diphenoxy-2-propyl acetate was as 96% and the isolation yield was 90%.

### Example 106

A reaction was conducted in the same manner as in Example 101 except that in Example 101, 2,6-DMPP was replaced by equal moles of tris(2,6-dimethoxy-4-phenoxyphenyl)phosphine. The analytical yield of intended 1,3-diphenoxy-2-propyl acetate was as 92% and the isolation yield was 86%.

### Example 107

In a 300-ml eggplant-shape flask were placed 18.9 g (105 mmol) of 2-methoxyethyl benzoate [a carboxylic acid ester of the formula (2) wherein R¹ is a phenyl group and OZ¹ is an organic group derived from 2-methoxyethanol] and 177 g (0.4 mmol) of 2,6-DMPP. Thereto was added 25.0 g of diglyme to prepare a homogeneous solution. The homogeneous solution was heated to 110° C. Thereto was dropwise added, in 30 minutes, a solution obtained by dissolving 18.5 g (100 mmol) of 4-chlorophenyl glycidyl ether in 25.0 g of diglyme. After the completion of the dropwise addition, stirring was conducted at the same temperature for 5 hours, after which the reaction mixture was returned to room temperature in about 10 minutes. Part of the reaction mixture was collected and subjected to a quantitative analysis by liquid chromatography using biphenyl as an internal standard. The analytical yield of intended 1-(4′-chlorophenoxymethyl)-2-(2-methoxyethoxy)ethyl benzoate was 90% (based on 4-chlorophenyl glycidyl ether). This reaction as well proceeded very satisfactorily. The reaction mixture was directly subjected to column chromatography to obtain 30.6 g of 1-(4′-chlorophenoxymethyl)-2-(2-methoxyethoxy)ethyl benzoate. The isolation yield was 84%.

### Example 108

A reaction was conducted in the same manner as in Example 107 except that in Example 107, 2-methoxyethyl benzoate was replaced by equal moles of acetic anhydride [an acid anhydride of the formula (3) wherein R¹ is a methyl group and OZ² is an organic group derived from acetic acid] and 4-chlorophenyl glycidyl ether was replaced by equal moles of PGE. The analytical yield of intended 2,3-diacetoxypropyl phenyl ether was 88%, and the isolation yield was 83%.

### Example 109

A reaction was conducted in the same manner as in Example 107 except that in Example 107, 2-methoxyethyl benzoate was replaced by equal moles of diphenyl carbonate [a carbonic acid ester of the formula (5) wherein R² is a phenyl group and OZ¹ is an organic group derived from phenol] and 4-chlorophenyl glycidyl ether was replaced by equal moles of PGE. The analytical yield of intended phenyl 1,3-diphenoxy-2-propyl carbonate was 87%, and the isolation yield was 80%.

### Example 110

A reaction was conducted in the same manner as in Example 107 except that in Example 107, 2-methoxyethyl benzoate was replaced by equal moles of methyl p-chlorophenyl carbonate [a carbonic acid ester of the formula (5) wherein R² is a methyl group and OZ¹ is an organic group derived from p-chlorophenol] and 4-chlorophenyl glycidyl ether was replaced by equal moles of PGE. The product was only methyl-1-phenoxy-3-(p-chlorophenoxy)-2-propyl carbonate having the substructure represented by the formula (9). The analytical yield thereof was 91% and the isolation yield was 83%.

### Example 111

A reaction was conducted in the same manner as in Example 107 except that in Example 107, 2-methoxyethyl benzoate was replaced by equal moles of methyl 2-methoxyethyl carbonate [a carbonic acid ester of the formula (5) wherein R² is a methyl group and OZ¹ is an organic group derived from 2-methoxyethanol] and 4-chlorophenyl glycidyl ether was replaced by equal moles of PGE. The products were methyl 1-phenoxy-3-(2-methoxyethoxy)-2-propyl carbonate having the substructure represented by the formula (9) and 2-methoxyethyl-3-mehtoxy-1-phenoxy-2-propyl carbonate having the substructure represented by the formula (10). The proportions of these products were about 1:1. The analytical yield of their total was 93% and the isolation yield was 88%.

### Example 112

A reaction was conducted in the same manner as in Example 107 except that in Example 107, 2-methoxyethyl benzoate was replaced by equal moles of methyl ethyl carbonate [a carbonic acid ester of the formula (5) wherein R²is a methyl group and OZ¹ is an organic group derived from ethanol] and 4-chlorophenyl glycidyl ether was replaced by equal moles of PGE. The products were methyl 1-phenoxy-3-ethoxy-2-propyl carbonate having the substructure represented by the formula (9) and ethyl 3-mehtoxy-1-phenoxy-2-propyl carbonate having the substructure represented by the formula (10). The proportions of these products were about 1:1. The analytical yield of their total was 93% and the isolation yield was 88%.

### Example 113

A reaction was conducted in the same manner as in Example 107 except that in Example 107, 2-methoxyethyl benzoate was replaced by equal moles of benzoic anhydride [a carboxylic anhydride of the formula (3) wherein R¹ is a phenyl group and OZ² is an organic group derived from benzoic acid] and 4-chlorophenyl glycidyl ether was replaced by equal moles of PGE. The analytical yield of intended 1,2-dibenzoyloxy-3-phenoxypropane was 97% and the isolation yield was 92%.

### Example 114

A reaction was conducted in the same manner as in Example 107 except that in Example 107, 2-methoxyethyl benzoate was replaced by equal moles of 2-naphthyl p-toluenesulfonate [a sulfonic acid ester of the formula (4) wherein R¹ is a p-tolyl group and OZ¹ is an organic group derived from 2-naphthol] and 4-chlorophenyl glycidyl ether was replaced by equal moles of PGE. The analytical yield of intended 1-(2-naphthyloxy)-3-phenoxy-2-propyl p-toluenesulfonate was 93% and the isolation yield was 89%.

### Example 115

A reaction was conducted in the same manner as in Example 107 except that in Example 107, 2-methoxyethyl benzoate was replaced by equal moles of 4-chlorophenyl methacrylate [a carboxylic acid ester of the formula (2) wherein R¹ is an isopropenyl group and OZ¹ is an organic group derived from 4-chlorophenol] and 4-chlorophenyl glycidyl ether was replaced by equal moles of PGE. The analytical yield of intended 1-(4-chlorophenoxy)-3-phenoxy-2-propyl methacrylate was 95% and the isolation yield was 90%.

### Example 116

A reaction was conducted in the same manner as in Example 107 except that in Example 107, 2-methoxyethyl benzoate was replaced by equal moles of methacrylic anhydride [a carboxylic acid anhydride of the formula (3) wherein R¹ is an isopropenyl group and OZ¹ is an organic group derived from methacrylic acid] and 4-chlorophenyl glycidyl ether was replaced by equal moles of PGE. The analytical yield of intended 2,3-di(isopropenylcarbonyloxy)propyl phenyl ether was 89% and the isolation yield was 85%.

### Example 117

A reaction was conducted in the same manner as in Example 107 except that in Example 107, 2-methoxyethyl benzoate was replaced by equal moles of methyl propanesulfonate [a sulfonic acid ester of the formula (4) wherein R¹ is a propyl group and OZ¹ is an organic group derived from methanol] and 4-chlorophenyl glycidyl ether was replaced by equal moles of PGE. The analytical yield of intended 1-methoxy-3-phenoxy-2-propyl propanesulfonate was 92% and the isolation yield was 86%.

### Example 118

A reaction was conducted in the same manner as in Example 107 except that in Example 107, 2-methoxyethyl benzoate was replaced by equal moles of 4-trifluoromethylphenyl ethylenesulfonate [a sulfonic acid ester of the formula (4) wherein R¹ is a vinyl group and OZ¹ is an organic group derived from 4-trifluoromethylphenol] and 4-chlorophenyl glycidyl ether was replaced by equal moles of PGE. The analytical yield of intended 1-phenoxy-3-(4-trifluoromethyl)phenoxy-2-propyl ethylenesulfonate was 87% and the isolation yield was 83%.

### Example 119

A reaction was conducted in the same manner as in Example 107 except that in Example 107, 2-methoxyethyl benzoate was replaced by equal moles of 3-benzyloxypropyl methanesulfonate [a sulfonic acid ester of the formula (4) wherein R¹ is a methyl group and OZ¹ is an organic group derived from 3-benzyloxypropanol] and 4-chlorophenyl glycidyl ether was replaced by equal moles of PGE. The analytical yield of intended 1-(3-benzyloxy)propoxy-3-phenoxy-2-propyl methanesulfonate was 94% and the isolation yield was 90%.

### Example 120

In a 200-ml autoclave were placed 72.3 g (420 mmol) of octyl acetate [a carboxylic acid ester of the formula (2) wherein R¹ is a methyl group and OZ¹ is an organic group derived form octanol] and 0.442 g (1.0 mmol) of 2,6-DMPP. The mixture was heated to 90° C. Then, while 23.2 g (400 mmol) of propylene oxide was fed intermittently so that the pressure during reaction could be kept at 0.3 MPa (absolute pressure), a reaction was conducted at the same temperature for 15 hours. The autoclave contents were cooled to room temperature in about 30 minutes. Part of the reaction mixture was collected and subjected to a quantitative analysis by gas chromatography. The analytical yield of intended 2-octyloxy-1-methylethyl acetate was 73%. The reaction mixture was subjected to column chromatography to obtain 60.8 g of 2-octyloxy-1-methylethyl acetate. The isolation yield was 66%.

### Example 121

A reaction was conducted in the same manner as in Example 107 except that in Example 107, 2-methoxyethyl benzoate was replaced by equal moles of diphenyl adipate [a carboxylic acid ester of the formula (2) wherein R¹ is a 4-(phenoxycarbonyl)butyl group and OZ¹ is an organic group derived from phenol] and 4-chlorophenyl glycidyl ether was replaced by double moles of PGE. The analytical yield of intended di(1-phenoxymethyl-2-phenoxyethyl) adipate was 90% and the isolation yield was 85%.

### Example 122

A reaction was conducted in the same manner as in Example 107 except that in Example 107, 2-methoxyethyl benzoate was replaced by equal moles of dimethyl terephthalate [a carboxylic acid ester of the formula (2) wherein R¹ is a 4-(methoxycarbonyl)phenyl group and OZ¹ is an organic group derived from methanol] and 4-chlorophenyl glycidyl ether was replaced by double moles of PGE. The analytical yield of intended di(1-phenoxymethyl-2-methoxyethyl) terephthalate was 88% and the isolation yield was 84%.

### Example 123

A reaction was conducted in the same manner as in Example 107 except that in Example 107, 2-methoxyethyl benzoate was replaced by equal moles of 1,4-di(acetoxycarbonyl)benzene [a carboxylic acid anhydride of the formula (3) wherein R¹ is a 4-(acetoxycarbonyl)phenyl group and OZ² is an organic group derived from acetic acid] and 4-chlorophenyl glycidyl ether was replaced by double moles of PGE. The analytical yield of intended di(1-phenoxymethyl-2-acetoxyethyl) terephthalate was 96% and the isolation yield was 91%.

### Synthesis Example 201

214.0 g (2.0 mol=hydroxyl group) of a novolac resin [trade name: PSM 4261, a product of Gun ei Chemical Industry Co., Ltd., hydroxyl equivalent: 107.0 g/eq, average molecular weight: 940 (polystyrene-reduced)] was fed into a glass-made reactor equipped with a thermometer, a dropping funnel, a reflux condenser, a nitrogen inlet tube, a stirrer, a pressure reducer (a handy aspirator) and an alkali trap. The reactor contents were heated to 1 200C. While a temperature of 120 to 125° C. was being kept, 281.1 g (2.0 mmol) of benzoyl chloride was added dropwise in 3 hours. After the completion of the dropwise addition, the reactor contents were heated to 160° C. in 1 hour, and aging was conducted at the same temperature for 12 hours.

During the dropwise addition and the aging, suction was made from the top of the reflux condenser to make slightly vacuum the reactor inside and keep the reactor inside at 70 to 100 kPa, whereby the hydrogen chloride gas generated was quickly removed out of the system. The hydrogen chloride gas removed out of the system was neutralized almost completely by the alkali trap provided between the top of the reflux condenser and the pressure reducer. After the completion of the aging, complete disappearance of benzoyl chloride in the resin formed was confirmed by gas chromatography, and the reaction was terminated.

Then, the vacuum was released and the reactor contents were cooled to 120° C. while nitrogen was fed into the reactor at a rate of 5 ml/min from the nitrogen inlet tube. While stirring was continued at the same temperature, a reaction was allowed to take place while 50 g of isopropyl alcohol was dropwise added in 30 minutes, in order to allow the residual benzoyl chloride left on the reactor wall to disappear completely. Stirring was continued for 30 minutes while isopropyl alcohol distilled at ordinary pressure was distilled per se out of the system. Then, the reactor contents were heated again to 160° C. and finally was reduced to lowest 70 kPa to distil off volatile components; then, the reactor residue was discharged into a SUS-made vat to obtain 401.9 g of an almost completely benzoylated resin at a yield of 95%.

Incidentally, the resin obtained was measured for hydroxyl equivalent, which was 3,000 g/eq or more, and detection was substantially impossible.

### Synthesis Example 202

Into the same reactor as in Synthesis Example 201 was fed 336 g (2.0 mol=hydroxyl group) of a phenol aralkyl resin [trade name: Milex XLC-4L, a product of Mitsui Chemicals, Inc., hydroxyl equivalent: 168 g/eq, average molecular weight: 1,276 (polystyrene-reduced)]. The resin was reacted with 281.1 g (2.0 mol) of benzoyl chloride in the same manner as in Synthesis Example 201 to obtain 511.4 g of a benzoylated resin at a yield of 94%.

Incidentally, the resin obtained was measured for hydroxyl equivalent, which was 3,000 g/eq or more, and detection was substantially impossible.

### Synthesis Example 203

Into the same reactor as in Synthesis Example 201 was fed 370 g (2.0 mol=hydroxyl group) of a phenol-dicyclopentadiene resin [trade name: DPR 5000, a product of Mitsui Chemicals, Inc., hydroxyl equivalent: 185 g/eq, average molecular weight: 810 (polystyrene-reduced)]. The resin was reacted with 281.1 g (2.0 mol) of benzoyl chloride in the same manner as in Synthesis Example 201 to obtain 543.4 g of a benzoylated resin at a yield of 94%.

Incidentally, the resin obtained was measured for hydroxyl equivalent, which was 3,000 g/eq or more, and detection was substantially impossible.

### Synthesis Example 204

Into a reactor provided with the same equipment as in Synthesis Example 201 were fed 214.0 g (2.0 mol=hydroxyl group) of a novolac resin [trade name: PSM 4261, a product of Gun ei Chemical Industry Co., Ltd., hydroxyl equivalent: 107.0 g/eq, average molecular weight: 940 (polystyrene-reduced)], 750 g of toluene and 152.8 g (1.932 mol) of pyridine. Stirring was conducted at room temperature. When the mixture became a homogeneos solution, 258.7 g (1.84 mol) of benzoyl chloride was dropwise added in 3 hours to give rise to a reaction. Since there was slight heat generation during the reaction, the reactor inside temperature was controlled at 30 to 40° C., by cooling. After the completion of the dropwise addition, aging was made for 3 hours while the same temperature was being kept, and the reaction was terminated.

After the termination of the reaction, 500 g of water was added to dissolve the formed precipitate (salt) to give rise to phase separation; water washing was repeated; when the pH of the washings became 7 and the absence of chlorine ion in the washings was confirmed by using an aqueous silver nitrate solution, the water washing was terminated. Then, toluene was distilled off under the conditions of maximum 150° C. and a vacuum of 70 kPa, to obtain 384.5 g of a novolac resin wherein about 92% of the hydroxyl group had been benzoylated, at a yield of 95%.

The resin had a hydroxyl equivalent of 2,535 g/eq. The degree of benzoylation of the resin, calculated from the hydroxyl equivalent was 91.98%.

### Example 201

There were preliminarily melt-kneaded, at 100° C. for 5 minutes, 0.1 gram equivalent (19.3 g ) of (A) an epoxy resin, i.e. a biphenol type epoxy resin of the general formula (IV) wherein L² is methyl [trade name: YX 4000H, a product of Yuka Shell Epoxy K.K., epoxy equivalent: 193 g/eq], 0.1 gram equivalent (21.1 g) of (B) a curing agent, i.e. a benzoylated phenol novolac resin of Synthesis Example 201 [functional group equivalent: 211.0 g/eq (calculated)], and 0.808 g (2 parts by weight*) of (C) a curing accelerator, i.e. tris(2,4-dimethoxyphenyl)phosphine (hereinafter abbreviated as BMPP) which is a phosphine compound of the general formula (I) wherein G¹ and G² are a methoxy group and G³ is a hydrogen atom. Then, sufficient melt-kneading was conducted at 80° C. to obtain a uniform resin mixture. This epoxy resin composition was measured for gelling time, which was 42 seconds at 175° C. (*: parts by weight relative to 100 parts by weight of the total of the epoxy resin and the curing agent)

The resin composition was also measured for curing behavior using a curastometer [CURELASTOMETER V Type, a product of Nichigo Shoji Sha, mold: P-200 (for resin), measurement temperature: 175° C., frequency: 100 cycles/min, amplitude angle: ±1°, sample amount: 4.5 g]. The time up to 10% curing was expressed by t'c (10) and the time up to 90% curing was expressed by t'c (90). The results are shown in Table I.

### Examples 202 to 203

Epoxy resin compositions were obtained in the same manner as in Example 201 except that in Example 201, the curing agent was changed to 0.1 gram equivalent of the benzoylated resin of Synthesis Example 202 or 203 and the curing accelerator was set at 2 parts by weight. The compositions were measured for gelling time and curing behavior using a curastometer. The results are shown in Table I.

Incidentally, the functional group equivalent of Synthesis Example 202 is 272.0 g/eq (calculated) and the functional group equivalent of Synthesis Example 203 is 289.0 g/eq (calculated).

### Examples 204 to 206

Epoxy resin compositions were obtained in the same manner as in Examples 201 to 203 except that in Examples 201 to 203, the curing accelerator was changed to 2 parts by weight of tris(2,4,6-trimethoxyphenyl)phosphine (hereinafter TMPP) of the general formula (I) wherein G¹ to G³ are all a methoxy group. The compositions were measured for gelling time and curing behavior using a curastometer. The results are shown in Table I.

### Examples 207 to 212

Epoxy resin compositions were obtained in the same manner as in Examples 201 to 206 except that in Examples 201 to 206, the epoxy resin was changed to 0.1 gram equivalent of an o-cresol novolac type epoxy resin [trade name: EOCN 102S, a product of Nippon Kayaku Co., Ltd., epoxy equivalent: 210 g/eq]. The compositions were measured for gelling time and curing behavior using a curastometer. The results are shown in Table I.

TABLE I

| | | | | | | (C) Curing | | | | |
|---|---|---|---|---|---|---|---|---|---|---|
| | (A) Epoxy resin | | (B) Curing agent | | | accelerator | | | | |
| | | Amount | | Esterification | Amount | | Amount | Gelling time | Curastotorque | |
| | | used | | percentage | used | | used | (175° C.) | T′c(10) | T′c(90) |
| | Kind | (g) | Kind | (%) | (G) | Kind | (phr) | (sec) | (min) | (min) |
| Ex. 202 | YX4000 | 19.3 | Syn. Ex. 202 | 100 | 27.2 | BMPP | 2 | 80 | 1.21 | 5.77 |
| Ex. 203 | YX4000 | 19.3 | Syn. Ex. 203 | 100 | 28.9 | BMPP | 2 | 83 | 1.22 | 5.80 |
| Ex. 204 | YX4000 | 19.3 | Syn. Ex. 201 | 100 | 21.1 | TMPP | 2 | 75 | 0.91 | 4.44 |
| Ex. 205 | YX4000 | 19.3 | Syn. Ex. 202 | 100 | 27.2 | TMPP | 2 | 78 | 1.20 | 5.70 |
| Ex. 206 | YX4000 | 19.3 | Syn. Ex. 203 | 100 | 28.9 | TMPP | 2 | 80 | 1.20 | 5.69 |
| Ex. 207 | EOCN102S | 21.0 | Syn. Ex. 201 | 100 | 21.1 | BMPP | 2 | 35 | 0.48 | 2.35 |
| Ex. 208 | EOCN102S | 21.0 | Syn. Ex. 202 | 100 | 27.2 | BMPP | 2 | 40 | 0.50 | 2.40 |
| Ex. 209 | EOCN102S | 21.0 | Syn. Ex. 203 | 100 | 28.9 | BMPP | 2 | 42 | 0.52 | 2.41 |
| Ex. 210 | EOCN102S | 21.0 | Syn. Ex. 201 | 100 | 21.1 | TMPP | 2 | 37 | 0.45 | 2.30 |
| Ex. 211 | EOCN102S | 21.0 | Syn. Ex. 202 | 100 | 27.2 | TMPP | 2 | 40 | 0.49 | 2.35 |
| Ex. 212 | EOCN102S | 21.0 | Syn. Ex. 203 | 100 | 28.9 | TMPP | 2 | 44 | 0.50 | 2.44 |

### Examples 213 to 218

Epoxy resin compositions were obtained respectively in the same manners as in Examples 201 to 206 except that in Examples 201 to 206, the epoxy resin was changed to 0.1 gram equivalent of a phenol aralkyl type epoxy resin [trade name: E-XLC-3L, a product of Mitsui Chemicals, Inc., epoxy equivalent: 238 g/eq]. The compositions were measured for gelling time and curing behavior using a curastometer. The results are shown in Table II.

### Comparative Example 201

An epoxy resin composition was obtained in the same manner as in Example 201 except that in Example 201, the curing accelerator was changed to 2 parts by weight of triphenylphosphine (hereinafter abbreviated as TPP). The composition was measured for gelling time; however, there was no gelling and the measurement of gelling time was impossible. Further, in the measurement by a curastometer, there was no increase in torque. The results are shown in Table II.

### Comparative Example 202

An epoxy resin composition was obtained in the same manner as in Example 207 except that in Example 207, the curing accelerator was changed to 2 parts by weight of TPP. The composition was measured for gelling time; however, there was no gelling and the measurement of gelling time was impossible. Further, in the measurement by a curastometer, there was no increase in torque. The results are shown in Table II.

### Comparative Example 203

An epoxy resin composition was obtained in the same manner as in Example 207 except that in Example 207, the curing accelerator was changed to 2 parts by weight of 2-methylimidazole (hereinafter abbreviated as 2MZ). The composition was measured for gelling time; however, there was no gelling and the measurement of gelling time was impossible. Further in the measurement by a curastometer, there was no increase in torque. The results are shown in Table II.

### Example 219

An epoxy resin composition was obtained in the same manner as in Example 201 except that in Example 201, the curing agent was changed to 0.1 gram equivalent (20.3 g) of a 92%-benzoylated phenol novolac resin of Synthesis Example 204 [functional group equivalent: 203.0 g/eq (calculated)] and the curing accelerator was set at 2 parts by weight. The composition was measured for gelling time and curing behavior using a curastometer. The results are shown in Table II.

### Example 220

An epoxy resin composition was obtained in the same manner as in Example 210 except that in Example 210, the curing agent was changed to 0.1 gram equivalent of a 92%-benzoylated phenol novolac resin of Synthesis Example 204 and the curing accelerator was set at 2 parts by weight. The composition was measured for gelling time and curing behavior using a curastometer. The results are shown in Table II.

### Comparative Example 204

An epoxy resin composition was obtained in the same manner as in Example 219 except that in Example 219, the curing accelerator was changed to 2 parts by weight of 2MZ. The composition was measured for gelling time; however, although there was a sign of gelling, no clear gelling was reached (measurement was stopped in 20 minutes). The results are shown in Table II.

### Comparative Example 205

An epoxy resin composition was obtained in the same manner as in Example 220 except that in Example 220, the curing accelerator was changed to 2 parts by weight of 2MZ. The composition was measured for gelling time; however, although there was a sign of gelling, no clear gelling was reached (measurement was stopped in 20 minutes). The results are shown in Table II.

TABLE II

| | | | | | | (C) Curing | | | | |
|---|---|---|---|---|---|---|---|---|---|---|
| | (A) Epoxy resin | | (B) Curing agent | | | accelerator | | | | |
| | | Amount | | Esterification | Amount | | Amount | Gelling time | Curastotorque | |
| | | used | | percentage | used | | used | (175° C.) | T′c(10) | T′c(90) |
| | Kind | (g) | Kind | (%) | (G) | Kind | (phr) | (sec) | (min) | (min) |
| Ex. 213 | E-XLC-3L | 23.8 | Syn. Ex. 201 | 100 | 21.1 | BMPP | 2 | 38 | 0.51 | 2.55 |
| Ex. 214 | E-XLC-3L | 23.8 | Syn. Ex. 202 | 100 | 27.2 | BMPP | 2 | 46 | 0.59 | 2.87 |
| Ex. 215 | E-XLC-3L | 23.8 | Syn. Ex. 203 | 100 | 28.9 | BMPP | 2 | 46 | 0.58 | 2.83 |
| Ex. 216 | E-XLC-3L | 23.8 | Syn. Ex. 201 | 100 | 21.1 | TMPP | 2 | 39 | 0.50 | 2.62 |
| Ex. 217 | E-XLC-3L | 23.8 | Syn. Ex. 202 | 100 | 27.2 | TMPP | 2 | 48 | 0.59 | 2.80 |
| Ex. 218 | E-XLC-3L | 23.8 | Syn. Ex. 203 | 100 | 28.9 | TMPP | 2 | 49 | 0.59 | 2.82 |
| Ex. 219 | YX4000 | 19.3 | Syn. Ex. 204 | 92 | 20.3 | BMPP | 2 | 77 | 0.93 | 4.51 |
| Ex. 220 | EOCN102S | 21.0 | Syn. Ex. 204 | 92 | 20.3 | TMPP | 2 | 44 | 0.50 | 2.51 |

| | | | | | | | | |
|---|---|---|---|---|---|---|---|---|
| Comp. Ex. 201 | YX4000 | 19.3 | Syn. Ex. 201 | 100 | 21.1 | TPP | 2 | There was no sign of gelling or |
| | | | | | | | | curing. |
| Comp. Ex. 202 | EOCN102S | 21.0 | Syn. Ex. 201 | 100 | 21.1 | TPP | 2 | There was no sign of gelling or |
| | | | | | | | | curing. |
| Comp. Ex. 203 | EOCN102S | 21.0 | Syn. Ex. 201 | 100 | 21.1 | 2MZ | 2 | There was no sign of gelling or |
| | | | | | | | | curing. |
| Comp. Ex. 204 | YX4000 | 19.3 | Syn. Ex. 204 | 92 | 20.3 | TPP | 2 | Gelling was slow and |
| | | | | | | | | measurement was stopped in |
| | | | | | | | | 20 minutes. |
| Comp. Ex. 205 | EOCN102S | 21.0 | Syn. Ex. 204 | 92 | 20.3 | 2MZ | 2 | Gelling was slow and |
| | | | | | | | | measurement was stopped in |
| | | | | | | | | 20 minutes. |

### Example 221

There were used YX 4000H as an epoxy resin, a benzoylated phenol novolac resin of Synthesis Example 201 as a curing agent, and 2 parts by weight of BMPP as a curing accelerator. A filler and other additives were added. The resulting composition was heat-kneaded using a roll to obtain a molding material for encapsulation having a formulation shown in Table III.

As the filler, there was used a silica (a product of Tatsumori K.K., trade name: YXK-35R).

The molding material was converted into a cured material using a transfer molding machine under the conditions of 175° C., 150 kg/cm² and 10 min. The cured material was subjected to after-curing under the conditions of 175° C., 8 hours and a nitrogen atmosphere for sufficient curing. The thus-obtained cured material was measured for properties. The results are shown in Table III.

Incidentally, the test methods used for measurement of properties are as follows.

Gelling Time

According to a gelling time measurement method using a hot plate, a sample was placed on a hot plate of 175° C., and there was measured a time from sample melting on hot plate to curing. The time was taken as gelling time.

Shore D Hardness During Release From Mold

Molding was conducted under the conditions of 175° C. and 300 seconds; immediately thereafter, a hardness when hot was measured using a Shore D hardness tester.

Spiral Flow Value

Using a mold for spiral flow measurement, a spiral flow value was measured in accordance with EMMI 1-66 under the conditions of 175° C. and 6.9 MPa (pressure).

Tq (Glass Transition Temperature)

Measurement was made in accordance with a TMA penetration method (Shimadzu TMA-DRW DT-30).

Flexural Strength and Modulus of Elasticity

A test piece of 80 mm (length)×10 mm (width)×4 mm (thickness) was molded using a transfer molding machine (molding conditions: 175° C.×300 seconds) and subjected to after-curing at 175° C. for 8 hours to produce a test sample. Using this sample, measurement was made according to JIS K 7171.

Moisture Absorption Percentage

A test piece was allowed to stand in a thermo-hygrostat of 85° C. and 85% for 168 hours and then measured for weight increase.

Crack Test

A semiconductor device sample for test was allowed to stand in a thermo-hygrostat of 85° C. and 85% for 168 hours and immediately placed in a frorinart solution (a product of Sumitomoto 3M Limited, trade name: FC-70) of 240° C. The number of semiconductor devices in which cracks generated in the package resin was counted. The result was indicated as a fraction wherein the numerator is the number of crack-generated semiconductor devices and the denominator is the number of total semiconductor devices tested.

### Examples 222 to 223

Molding materials for encapsulation were obtained in the same manner as in Example 221 except that in Example 221, the curing agent was changed to that of Synthesis Example 202 or 203 and the formulation was changed as shown in Table III. The molding materials were converted into respective cured materials in the same manner as in Example 221, and each cured material was measured for properties. The results are shown in Table III.

### Examples 224 to 226

Molding materials for encapsulation were obtained in the same manners as in Examples 221 to 223 except that in Examples 221 to 223, the curing accelerator was changed to TMPP and the respective formulations were changed as shown in Table III. The molding materials were converted into respective cured materials in the same manners as in Examples 221 to 223, and each cured material was measured for properties. The results are shown in Table III.

### Examples 227 to 232

Molding materials for encapsulation were obtained in the same manners as in Examples 221 to 226 except that in Examples 221 to 226, the epoxy resin was changed to an o-cresol novolac type epoxy resin [trade name: EOCN102S, a product of Nippon Kayaku Co., Ltd., epoxy equivalent: 210 g/eq] and the respective formulations were changed as shown in Table III. The molding materials were converted into respective cured materials in the same manners as in Examples 221 to 226, and each cured material was measured for properties. The results are shown in Table III.

TABLE III
(A)

| | | | (B) Curing agent | | | Silica | | | | | |
|---|---|---|---|---|---|---|---|---|---|---|---|
| | | | | Esterification | | (YXK- | | | (C) Curing | | Gelling time |
| | (A) Epoxy resin | | | percentage | | 35R) | Camauba | Hechst E | accelerator | | (175 ° C.) |
| | Kind | wt % | Kind | (%) | wt % | Wt % | Wt % | Wt % | Kind | phr | sec |
| Ex. 221 | YX4000 | 5.97 | Syn. Ex. 201 | 100 | 6.53 | 87 | 0.25 | 0.25 | BMPP | 2 | 59 |
| Ex. 222 | YX4000 | 5.19 | Syn. Ex. 202 | 100 | 7.31 | 87 | 0.25 | 0.25 | BMPP | 2 | 64 |
| Ex. 223 | YX4000 | 5.01 | Syn. Ex. 203 | 100 | 7.49 | 87 | 0.25 | 0.25 | BMPP | 2 | 66 |
| Ex. 224 | YX4000 | 5.97 | Syn. Ex. 201 | 100 | 6.53 | 87 | 0.25 | 0.25 | TMPP | 2 | 60 |
| Ex. 225 | YX4000 | 5.19 | Syn. Ex. 202 | 100 | 7.31 | 87 | 0.25 | 0.25 | TMPP | 2 | 64 |
| Ex. 226 | YX4000 | 5.01 | Syn. Ex. 203 | 100 | 7.49 | 87 | 0.25 | 0.25 | TMPP | 2 | 68 |
| Ex. 227 | EOCN102S | 6.24 | Syn. Ex. 201 | 100 | 6.26 | 87 | 0.25 | 0.25 | BMPP | 2 | 33 |
| Ex. 228 | EOCN102S | 5.45 | Syn. Ex. 202 | 100 | 7.05 | 87 | 0.25 | 0.25 | BMPP | 2 | 35 |
| Ex. 229 | EOCN102S | 5.26 | Syn. Ex. 203 | 100 | 7.24 | 87 | 0.25 | 0.25 | BMPP | 2 | 38 |
| Ex. 230 | EOCN102S | 6.24 | Syn. Ex. 201 | 100 | 6.26 | 87 | 0.25 | 0.25 | TMPP | 2 | 33 |
| Ex. 231 | EOCN102S | 5.45 | Syn. Ex. 202 | 100 | 7.05 | 87 | 0.25 | 0.25 | TMPP | 2 | 36 |
| Ex. 232 | EOCN102S | 5.26 | Syn. Ex. 203 | 100 | 7.24 | 87 | 0.25 | 0.25 | TMPP | 2 | 37 |

(B)

| | | | Flexural strength | | Water absorption | | |
|---|---|---|---|---|---|---|---|
| | Spiral flow | Shore D hardness during | (23 ° C.) | Modulus of elasticity | (85° C./85%/168 hr) | Tg | Crack test |
| | cm | release from mold | N/mm² | N/mm² | % | ° C. | ?/10 |
| Ex. 221 | 127 | 85 | 150 | 23800 | 0.153 | 110 | 0/10 |
| Ex. 222 | 131 | 85 | 147 | 23800 | 0.147 | 102 | 0/10 |
| Ex. 223 | 132 | 85 | 140 | 23800 | 0.148 | 103 | 0/10 |
| Ex. 224 | 127 | 85 | 150 | 23800 | 0.153 | 110 | 0/10 |
| Ex. 225 | 130 | 85 | 147 | 23800 | 0.147 | 102 | 0/10 |
| Ex. 226 | 130 | 85 | 140 | 23800 | 0.148 | 103 | 0/10 |
| Ex. 227 | 52 | 90 | 148 | 21000 | 0.158 | 121 | 0/10 |
| Ex. 228 | 52 | 90 | 145 | 21000 | 0.152 | 117 | 0/10 |
| Ex. 229 | 54 | 90 | 146 | 21000 | 0.153 | 117 | 0/10 |
| Ex. 230 | 52 | 90 | 147 | 21000 | 0.159 | 120 | 0/10 |
| Ex. 231 | .53 | 90 | 145 | 21000 | 0.153 | 117 | 0/10 |
| Ex. 232 | .53 | 90 | 146 | 21000 | 0.153 | 117 | 0/10 |

Notes: Carnauba: Carnauba wax
Hechst E: Hechst wax E (trade name)

### Examples 233 to 238

Molding materials for encapsulation were obtained in the same manners as in Examples 221 to 226 except that in Examples 221 to 226, the epoxy resin was changed to a phenol aralkyl type epoxy resin [trade name: E-XLC-3L, a product of Mitsui Chemicals, Inc., epoxy equivalent: 238 g/eq] and the respective formulations were changed as shown in Table IV. The molding materials were converted into respective cured materials in the same manners as in Examples 221 to 226, and each cured material was measured for properties. The results are shown in Table IV.

### Examples 239 to 240

Molding materials for encapsulation were obtained in the same manners as in Examples 221 and 227 except that in Examples 221 and 227, the curing agent was changed to the benzylated resin of Synthesis Example 204 and the respective formulations were changed as shown in Table IV. The molding materials were converted into respective cured materials in the same manners as in Examples 221 and 227, and each cured material was measured for properties. The results are shown in Table IV.

### Comparative Example 206

A molding material for encapsulation was obtained in the same manner as in Example 227 except that in Example 227, the curing agent was changed to a non-esterified novolac resin [trade name: PSM 4261, a product of Gun ei Chemical Industry Co., Ltd., hydroxyl equivalent: 107.0 g/eq, average molecular weight: 940 (polystyrene-reduced)], the curing accelerator was changed to 2 parts by weight of 2MZ and the formulation was changed as shown in Table IV. The molding material was converted into a cured material in the same manner as in Example 227, and the cured material was measured for properties. The results are shown in Table IV.

TABLE IV
(A)

| | | | (B) Curing agent | | | Silica | | | | | |
|---|---|---|---|---|---|---|---|---|---|---|---|
| | | | | Esterification | | (YXK- | | | (C) Curing | | Gelling time |
| | (A) Epoxy resin | | | percentage | | 35R) | Camauba | Hechst E | accelerator | | (175 ° C.) |
| | Kind | wt % | Kind | (%) | wt % | Wt % | Wt % | Wt % | Kind | phr | sec |
| Ex. 233 | E-XLC-3L | 6.63 | Syn. Ex. 201 | 100 | 5.87 | 87 | 0.25 | 0.25 | BMPP | 2 | 59 |
| Ex. 234 | E-XLC-3L | 5.83 | Syn. Ex. 202 | 100 | 6.67 | 87 | 0.25 | 0.25 | BMPP | 2 | 64 |
| Ex. 235 | E-XLC-3L | 5.65 | Syn. Ex. 203 | 100 | 6.85 | 87 | 0.25 | 0.25 | BMPP | 2 | 66 |
| Ex. 236 | E-XLC-3L | 6.63 | Syn .Ex. 201 | 100 | 5.87 | 87 | 0.25 | 0.25 | TMPP | 2 | 60 |
| Ex. 237 | E-XLC-3L | 5.83 | Syn. Ex. 202 | 100 | 6.67 | 87 | 0.25 | 0.25 | TMPP | 2 | 64 |
| Ex. 238 | E-XLC-3L | 5.65 | Syn. Ex. 203 | 100 | 6.85 | 87 | 0.25 | 0.25 | TMPP | 2 | 68 |
| Ex. 239 | YX4000 | 6.10 | Syn. Ex. 204 | 92 | 6.40 | 87 | 0.25 | 0.25 | TMPP | 2 | 33 |
| Ex. 240 | EOCN102S | 6.38 | Syn. Ex. 204 | 92 | 6.12 | 87 | 0.25 | 0.25 | TMPP | 2 | 35 |
| Comp. | EOCN102S | 8.27 | PSM4261 | 0 | 4.23 | 87 | 0.25 | 0.25 | 2MZ | 2 | 24 |
| Ex. 206 | | | | | | | | | | | |

(B)

| | | | Flexural strength | | Water absorption | | |
|---|---|---|---|---|---|---|---|
| | Spiral flow | Shore D hardness during | (23 ° C.) | Modulus of elasticity | (85° C./85%/168 hr) | Tg | Crack test |
| | cm | release from mold | N/mm² | N/mm² | % | ° C. | ?/10 |
| Ex. 233 | 127 | 85 | 150 | 23800 | 0.153 | 110 | 0/10 |
| Ex. 234 | 131 | 85 | 147 | 23800 | 0.147 | 102 | 0/10 |
| Ex. 235 | 132 | 85 | 140 | 23800 | 0.148 | 103 | 0/10 |
| Ex. 236 | 127 | 85 | 150 | 23800 | 0.153 | 110 | 0/10 |
| Ex. 237 | 130 | 85 | 147 | 23800 | 0.147 | 102 | 0/10 |
| Ex. 238 | 130 | 85 | 140 | 23800 | 0.148 | 103 | 0/10 |
| Ex. 239 | 52 | 90 | 148 | 21000 | 0.158 | 121 | 0/10 |
| Ex. 240 | 52 | 90 | 145 | 21000 | 0.152 | 117 | 0/10 |
| Comp. | .28 | 90 | 150 | 20000 | 0.152 | 158 | 10/10 |
| Ex. 206 | | | | | | | |

Notes: Carnauba: Carnauba wax
Hechst E: Hechst wax E (trade name)

As described in the above Examples 201 to 240, the epoxy resin composition of the second invention using an esterified phenol resin as a curing agent is low in moisture absorption and has properties suitable for IC encapsulating material; however, when a conventional curing accelerator such as triphenylphosphine, imidazole or the like is used, no curing is achieved as seen in Comparative Examples 201 to 206.

That is, as shown in the second invention, a particular triarylphosphine compound specifically promotes a reaction between epoxy group and ester group. This finding has led to the completion of the present invention. As shown in Examples 201 to 220, when a phosphine compound having a particular substituent is used, sufficient curability is exhibited; however, no curing takes place with a conventional general-purpose curing agent represented by triphenylphosphine or imidazole.

As seen in Examples 221 to 240, when ester group-containing resins were used as a curing agent for epoxy resin, molded materials sufficient as an encapsulating material could be obtained. All of these materials are low in moisture absorption, pass the crack test, and exhibit a high effect. When these materials are compared with Comparative Example 206 wherein a non-esterified novolac resin was used as a curing agent, the difference is obvious. The epoxy resin composition of the second invention is evident in the difference in performance as encapsulating material for semiconductor.

### INDUSTRIAL APPLICABILITY

According to the process of the first invention, a reaction of an epoxy compound with a carboxylic acid ester, a carboxylic acid anhydride, a sulfonic acid ester or a carbonic acid ester can be carried out under mild conditions as compared with a conventional process and, moreover, an intended oxyalkylene derivative corresponding to the above ester or anhydride can be produced at a high yield.

The epoxy resin composition of the second invention can be used in those industrial fields where conventional epoxy resin compositions have been used. The composition is superior in productivity particularly when used as an encapsulating material for semiconductor. Further, the epoxy resin composition, when cured, shows sufficient properties as an encapsulating material and is superior in crack resistance, etc. The composition is superior also in moisture absorption resistance when cured.

1. A process for producing an organic compound, characterized by conducting an organic reaction in the presence of a phosphine compound represented by the following formula (1). 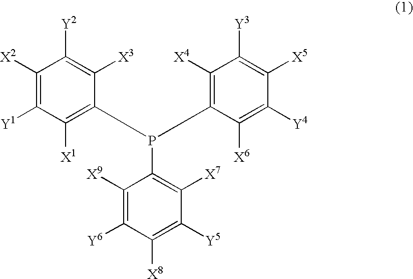
[in the formula (1), X¹ to X⁹ and Y¹ to Y⁶ are each independently a hydrogen atom, an aliphatic or alicyclic hydrocarbon group of 1 to 10 carbon atoms, an aromatic hydrocarbon group of 6 to 10 carbon atoms, an alkoxy group of 1 to 10 carbon atoms, or an aryloxy group of 6 to 10 carbon atoms, with a proviso that at least three of X¹ to X⁹ are an alkoxy group of 1 to 10 carbon atoms].

2. A process for producing an organic compound according to claim 1, characterized in that the organic reaction conducted in the presence of a phosphine compound represented by the formula (1) is a reaction between an epoxy compound and an carboxylic acid ester represented by the following formula (2), a carboxylic acid anhydride represented by the following formula (3), a sulfonic acid ester represented by the following formula (4), or a carbonic acid ester represented by the following formula (5) 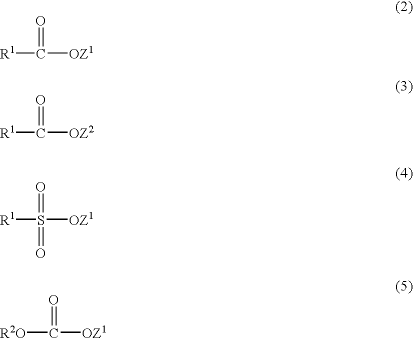
[in the formulas (2) to (5), R¹ is a hydrogen atom or an organic group containing 1 to 35 carbon atoms; R² is an aliphatic hydrocarbon group of 1 to 35 carbon atoms, or an aromatic hydrocarbon group of 6 to 35 carbon atoms; OZ¹ is an organic group formed by elimination of active hydrogen from an alcohol or a phenol; and OZ²is an organic group formed by elimination of active hydrogen from a carboxylic acid].

3. A process for producing an organic compound according to claim 1, wherein in the phosphine compound represented by the formula (1), at least three of the X¹ to X⁹ are a methoxy group and remainders are each independently selected from a hydrogen atom, a methyl group and a methoxy group.

4. A process for producing an organic compound according to claim 2, wherein in the phosphine compound represented by the formula (1), Y¹ to Y⁶ are each independently selected from a hydrogen atom, a methyl group and a methoxy group.

5. A process for producing an organic compound according to claim 2, wherein the phosphine compound represented by the formula (1) is any of tris(2,4-dimethoxyphenyl)phosphine, tris(2,6-dimethoxyphenyl)phosphine and tris(2,4,6-trimethoxyphenyl)phosphine.

6. A process for producing an organic compound according to claim 2, wherein the epoxy compound is an aliphatic, alicyclic or aromatic epoxy compound consisting of carbon atom, hydrogen atom and oxygen atom of epoxy group, or an aliphatic, alicyclic or aromatic epoxy compound having ether linkage.

7. A process for producing an organic compound according to claim 2, wherein the R¹ of the formulas (2) to (4) is an alkyl group of 1 to 35 carbon atoms, an alkenyl group of 2 to 35 carbon atoms, an aryl group of 6 to 35 carbon atoms, an aliphatic hydrocarbon group containing 3 to 35 carbon atoms and having one or more carboxylic acid ester groups, an aromatic hydrocarbon group containing 8 to 35 carbon atoms and having one or more carboxylic acid ester groups, or an aromatic hydrocarbon group containing 8 to 35 carbon atoms and having one or more carboxylic acid anhydride groups.

8. A process for producing an organic compound according to claim 2, wherein the OZ¹ of the formulas (2), (4) and (5) is an organic group derived from an aliphatic alcohol consisting of carbon atom, hydrogen atom and oxygen atom of alcoholic hydroxyl group, an aliphatic alcohol having ether linkage, a phenol consisting of carbon atom, hydrogen atom and oxygen atom of phenolic hydroxyl group, or a halogen atom-containing phenol.

9. A process for producing an organic compound according to claim 2, wherein the OZ² of the formula (3) is an organic group derived from an aliphatic or aromatic carboxylic acid consisting of carbon atom, hydrogen atom and oxygen atom of carboxyl group.

10. A process for producing an organic compound according to claim 2, wherein the R² of the formula (5) is an alkyl group of 1 to 35 carbon atoms or an aromatic hydrocarbon group of 6 to 12 carbon atoms.

11. A process for producing an organic compound according to claim 2, wherein in the carboxylic acid ester represented by the formula (2), R¹ is an alkyl group of 1 to 6 carbon atoms, an alkenyl group of 2 to 4 carbon atoms, an aryl group of 6 to 10 carbon atoms, an aliphatic hydrocarbon group containing 3 to 13 carbon atoms and having one or more carboxylic acid ester groups, or an aromatic hydrocarbon group containing 8 to 16 carbon atoms and having one or more carboxylic acid ester groups; and OZ¹ is an organic group derived from an aliphatic alcohol of 1 to 20 carbon atoms consisting of carbon atom, hydrogen atom and oxygen atom of alcoholic hydroxyl group or a phenol of 6 to 27 carbon atoms consisting of carbon atom, hydrogen atom and oxygen atom of phenolic hydroxyl group.

12. An epoxy resin composition containing
(A) an epoxy compound having two or more functions or an epoxy resin having two or more functions,
(B) a curing agent which is an ester group-containing compound or an ester group-containing resin formed by acylating the hydroxyl group of a phenol compound having two or more functions or a phenol resin having two or more functions, and
(C) a curing accelerator,
characterized in that 30 to 100% by weight of the total curing accelerator (C) contains essentially a phosphine compound represented by the following formula (1). 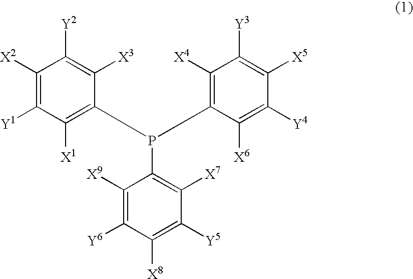
[in the formula (1), X¹ to X⁹ and Y¹ to Y⁶ are each independently a hydrogen atom, an aliphatic or alicyclic hydrocarbon group of 1 to 10 carbon atoms, an aromatic hydrocarbon group of 6 to 10 carbon atoms, an alkoxy group of 1 to 10 carbon atoms, or an aryloxy group of 6 to 10 carbon atoms, with a proviso that at least three of X¹ to X⁹ are an alkoxy group of 1 to 10 carbon atoms].

13. An epoxy resin composition containing
(A) an epoxy compound having two or more functions or an epoxy resin having two or more functions,
(B) a curing agent which is an ester group-containing compound or an ester group-containing resin formed by acylating the hydroxyl group of a phenol compound having two or more functions or a phenol resin having two or more functions, and
(C) a curing accelerator,
characterized in that 30 to 100% by weight of the total curing accelerator (C) contains essentially a phosphine compound represented by the following formula (I) 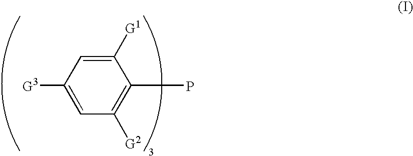
(in the above formula, G¹ to G³ are each independently a hydrogen atom and an alkoxy group of 1 to 6 carbon atoms, with a proviso that G¹ and G² are not a hydrogen atom simultaneously).

14. An epoxy resin composition according to claim 13, wherein the phosphine compound represented by the general formula (I) is tris(2,4-dimethoxyphenyl)phosphine, tris(2,6-dimethoxyphenyl)phosphine or tris(2,4,6-trimethoxyphenyl)phosphine.

15. An epoxy resin composition according to claim 13, wherein the acyl group of the ester group-containing compound or the ester group-containing resin formed by acylating the hydroxyl group of a phenol compound having two or more functions or a phenol resin having two or more functions is an acetyl group or a benzoyl group.

16. An epoxy resin composition according to claim 13, wherein the acyl group of the ester group-containing compound or the ester group-containing resin formed by acylating the hydroxyl group of a phenol compound having two or more functions or a phenol resin having two or more functions is an acetyl group or a benzoyl group, and the molar ratio of the acetyl group/the benzoyl group is in a range of 99/1 to 1/99.

17. An epoxy resin composition according to claim 13, which further contains
(D) an organic and/or inorganic filler
in an amount of 100 to 1,900 parts by weight relative to 100 parts by weight of a total of (A) the epoxy compound having two or more functions or the epoxy resin having two or more functions and (B) the curing agent.

18. An epoxy resin cured material obtained by thermosetting an epoxy resin composition set forth in claim 13.

19. A semiconductor device obtained by encapsulating a semiconductor integrated circuit using an epoxy resin composition set forth in claim 13.
